(19) United States
(12) Patent Application Publication
(10) Pub. No.: US 2025/0004687 A1
(43) Pub. Date: Jan. 2, 2025

(54) INTERFACE DISPLAY METHOD AND APPARATUS

(71) Applicant: Huawei Technologies Co., Ltd., Shenzhen (CN)

(72) Inventors: Yunjing Zhao, Shenzhen (CN); Che Yan, Toronto (CA)

(21) Appl. No.: 18/710,492

(22) PCT Filed: Nov. 8, 2022
(86) PCT No.: PCT/CN2022/130491

§ 371 Date: May 15, 2024

(30) Foreign Application Priority Data
Nov. 30, 2021 (CN) 202111453343.X

(51) Int. Cl. G06F 3/14; G06F 1/16; G06F 3/04842; G06F 3/0486; G06F 3/04883; G06F 40/58; G06V 30/10

(52) U.S. Cl. CPC G06F 3/1431; G06F 1/1677; G06F 3/04842; G06F 3/0486; G06F 3/04883; G06F 40/58; G06V 30/10

(57) ABSTRACT

Example methods and electronic devices are provided. An example method is applied to an electronic device, where the electronic device includes a first display and a second display. The first display is electrically connected to the second display. The example method includes determining second display data based on first display data in response to an operation on a display window on the first display. The first display data is displayed in the display window on the first display. Further, the second display data corresponds to a selected control in the first display data. Further still, the second display data is smaller or simpler than the first display data. The example method further includes displaying, on the second display, a window corresponding to the second display data.

### CROSS-REFERENCE TO RELATED APPLICATIONS

This application is a National Stage of International Application No. PCT/CN2022/130491 filed on Nov. 8, 2022, which claims priority to Chinese Patent Application No. 202111453343.X, filed on Nov. 30, 2021. Both of the aforementioned applications are hereby incorporated by reference in their entireties.

### TECHNICAL FIELD

This application relates to the field of artificial intelligence, and in particular, to an interface display method and apparatus.

### BACKGROUND

As a computer application ecosystem is gradually enriched and application functions become more complex, a single-screen display cannot meet user's requirement for office efficiency. Many users choose to use two or more displays when working on desktops. In some common dual-screen devices, for example, a dual screen is divided into a plane B and a plane C, and both the plane B and the plane C may display data. For example, the plane B is used as a primary screen for display, and the plane C displays some control buttons or information related to content displayed on the plane B. Generally, the plane B and the plane C have a specific angle, which is inconvenient for user operations.

### SUMMARY

This application relates to the field of artificial intelligence, and this application provides an interface display method and apparatus, to improve manipulation of a user on an electronic device and improve user experience.

In view of this, according to a first aspect, this application provides an interface display method, applied to an electronic device. The electronic device includes a first display and a second display, the first display is electrically connected to the second display, and the method includes: determining second display data based on first display data in response to an operation on a display window on a first display, where the first display data is data displayed in the display window on the first display, the second display data includes data corresponding to a selected control in the first display data, and the second display data is less than the first display data; and displaying, on the second display, a window corresponding to the second display data.

Therefore, in implementations of this application, the second display data can be determined based on the first display data in response to the operation on the display window on the first display, and the second display data can be displayed on a second display. The second display data includes the data corresponding to the selected control in the first display data, and is less than the first display data, so that a more simplified window can be displayed on the second display, thereby facilitating a user operation and improving user experience.

In a possible implementation, the method further includes: if the second display includes a plurality of display windows, in response to a slide operation on the plurality of display windows, selecting, on the second display based on the slide operation, a preset quantity of windows from the plurality of display windows for display, where the plurality of display windows do not overlap on the second display.

Therefore, in implementations of this application, when there are the plurality of display windows on the second display, the plurality of display windows are displayed in a non-overlapping manner, and a user can slide to view a hidden window, so that the user can perform a simpler operation, thereby having better visual effect and improving user experience.

In a possible implementation, the operation on the display window corresponding to the first display data includes at least one of the following operations performed on the first display: a drag operation, a close operation, a minimize operation, control selection, file selection, a play operation, a gesture operation, or a fold operation; and the drag operation includes an operation of moving the display window after the display window is selected, the close operation is an operation of closing the display window, the minimize operation is an operation of hiding the display window, the control selection is an operation of selecting a control in the display window, the file selection is an operation of selecting a file displayed in the display window, the play operation is an operation of playing data displayed in the display window, the gesture operation is an operation formed by a gesture for controlling the display window, and the fold operation is adjusting an included angle between the first display and the second display.

Therefore, in implementations of this application, the user can transfer, in a plurality of manners, a window displayed on the first display to the second display for display, and the user can perform an operation in a plurality of manners, to adapt to a plurality of scenarios, especially in some scenarios in which the user is inconvenient to perform the operation. The plurality of manners provided in this application can be used to perform the operation more conveniently, thereby improving user experience.

In a possible implementation, if the operation on the display window corresponding to the first display data includes the drag operation, the determining second display data based on first display data includes: using at least one type of data in the first display data as the second display data; and the displaying, on the second display, a window corresponding to the second display data includes: determining a location, on the second display, of the display window of the second display data based on a location at which a cursor is released.

Therefore, in implementations of this application, the user can very conveniently drag the window displayed on the first display to the second display for display, thereby improving user experience.

In a possible implementation, if the operation on the display window corresponding to the first display data includes the close operation or the minimize operation, the determining second display data based on first display data includes: scaling up or scaling down at least one type of data in the first display data, and/or deleting at least one type of data in the first display data, to obtain the second display data.

Therefore, in implementations of this application, when the user closes or minimizes the window displayed on the first display, a simplified window can be displayed on the second display, so that the user can more conveniently observe content in the closed or minimized window, thereby improving user experience.

In a possible implementation, if the operation on the display window corresponding to the first display data includes the file selection, and a text in the display window is selected, the determining second display data based on first display data includes: using the selected text as the second display data; or translating the selected text, to obtain the second display data based on a translation result; or performing searching based on the selected text, to obtain the second display data based on a search result; or arranging the selected text, or obtaining an arrangement format corresponding to the selected text, to obtain the second display data; or if the selected text includes a value, performing exchange rate conversion on the value, to obtain the second display data.

Therefore, in implementations of this application, when selecting the text on the first display, the user can perform a specific operation based on a specific application scenario and display the selected text on the second display, for example, directly display the selected text on the second display, or perform operations such as searching, typesetting, translation, or exchange rate conversion, so that intelligent user recommendation can be implemented, to adapt to a plurality of application scenarios, thereby having a strong generalization capability and improving user experience.

In a possible implementation, if the operation on the display window corresponding to the first display data includes the file selection, and an image in the display window is selected, the determining second display data based on first display data may include: using the selected image as the second display data; or searching for a related image of the selected image, to obtain the second display data based on the related image; or performing target detection on the selected image, to obtain the second display data; or performing text recognition on the selected image, to obtain the second display data based on a recognized text.

In implementations of this application, when selecting the image, the user can perform display, searching, target detection, text recognition, or the like based on the image, so that different operations can be performed in different scenarios, thereby improving user experience.

In a possible implementation, if the operation on the display window corresponding to the first display data includes the play operation, the determining second display data based on first display data includes: obtaining, from the first display data, data related to a picture played on the first display, to obtain the second display data.

Therefore, in implementations of this application, when the user plays data on the first display, related data can be played on the second display, so that the user can observe the related data on the second display in time, thereby improving user experience.

In a possible implementation, if the operation on the display window corresponding to the first display data includes the gesture operation, the determining second display data based on first display data may include: if detecting that the gesture corresponding to the gesture operation is a preset gesture, using at least one type of data in the first display data as the second display data.

Therefore, in implementations of this application, the user can conveniently move, by using the gesture operation, the data in the first display to the second display for display.

In a possible implementation, if the operation on the display window corresponding to the first display data includes the fold operation, and the included angle between the first display and the second display is within a preset range, the determining second display data based on first display data includes: using the first display data as the second display data.

Therefore, in implementations of this application, for a foldable display device, when the fold operation is detected, the data in the first display can be moved to the second display, so that a holding posture of the user for the device can be adapted, thereby improving user experience.

In a possible implementation, the displaying, on the second display, a window corresponding to the second display data includes: if detecting that a running application is an application in a preset list, or if detecting that the electronic device is in a preset mode, displaying, on the second display, the window corresponding to the second display data.

Therefore, in implementations of this application, when the running program is a preset program, or when the electronic device is in the preset mode, the second display data can be displayed on the second display. The preset list may be preset by the user, so that data, corresponding to an application, that can be displayed on the second display can be selected based on a requirement of the user, thereby improving user experience. Alternatively, when the electronic device is in the preset mode, the data can be displayed on the second display, thereby improving user experience.

In a possible implementation, a first window on the second display includes third display data, the third display data includes an interface of an application, and the method may further include: in response to a click operation on a control in the interface of the application, obtaining fourth display data corresponding to the control clicked by the click operation, and replacing the third display data displayed in an area corresponding to the first window with the fourth display data, where the first window is any window displayed on the second display.

Therefore, in implementations of this application, when the user clicks the control in the display interface corresponding to the application displayed on the second display, the click operation of the user can be responded to, so that the user can perform man-machine interaction on the second display, thereby improving user experience.

In a possible implementation, a preset area on the second display includes at least one displayed preset window, and the at least one preset window displays at least one of a calendar, weather information, a trip record, a memo, or a note.

Therefore, in implementations of this application, common information such as the calendar, weather, a trip, the memo, or the note can be continuously displayed on the second display, so that the user can learn of required information in time on the second display, thereby improving user experience.

In a possible implementation, the method may further include: if detecting a drag operation on fifth display data displayed on the second display, using an area, corresponding to a location at which a cursor is released, on the second display as a display area of the fifth display data.

Therefore, in implementations of this application, the user can adjust, by using the drag operation, a location of a window displayed on the second display, so that the user can arrange the window displayed on the second display based on a requirement, thereby improving user experience.

In a possible implementation, the method may further include: obtaining information sent by at least one terminal, and displaying, on the second display, the information sent by the at least one terminal.

Therefore, in implementations of this application, information sent by another terminal can be received, and displayed on the second display, so that cross-device interaction can be implemented, and information is displayed on the second display in a time, thereby improving user experience.

In a possible implementation, the information sent by the at least one terminal includes data related to an application corresponding to the first display data.

In implementations of this application, the electronic device can run an application. If information that is sent by another device and is related to the application is received, the received information can be displayed on the second display, so that the user can observe required information in time on the second display, thereby improving user experience.

In a possible implementation, the second display includes at least one window of a preset size that is arranged in a non-overlapping manner, and the displaying, on the second display, the information sent by the at least one terminal may include: displaying, in the at least one window of the preset size that is arranged in the non-overlapping manner, the information sent by the at least one terminal.

Therefore, in implementations of this application, the window on the second display may be a card window, and the user can observe the received information at a preset limited window location, thereby improving user experience.

In a possible implementation, the obtaining information sent by at least one terminal may include: obtaining information sent by a plurality of terminals, where the plurality of terminals include a first terminal and a second terminal; and the displaying, on the second display, the information sent by the at least one terminal may include: displaying, in a second window on the second display, information sent by the first terminal; and displaying, in the second window in response to a switch operation on the second window, information sent by the second terminal.

Therefore, in implementations of this application, when information sent by a plurality of terminals is received, information corresponding to one of the terminals can be displayed in a window, and the user can switch to display an operation corresponding to another terminal, so that utilization of a display area on the second display can be improved, and redundant display information can be reduced.

In a possible implementation, the obtaining information sent by at least one terminal may include: sending a request message to a server, to indicate the server to send a verification message to a third terminal, where the third terminal is any one of the at least one terminal; and receiving information sent by the third terminal, where the information sent by the third terminal includes the verification message.

Therefore, in implementations of this application, the electronic device can send the request message to the server, to request the server to send the verification message to the terminal, and the terminal sends the verification message to the electronic device. This is applied to a scenario in which an identity is verified for the electronic device. The user can view the verification message on the second display without opening the terminal, thereby improving user experience.

In a possible implementation, the displaying, on the second display, the information sent by the at least one terminal may include: if detecting that a fourth terminal is in a screen-off state, displaying, on the second display, information sent by the fourth terminal, where the fourth terminal is any one of the at least one terminal; or if information sent by a fourth terminal includes information generated by a first application, and the first application is an application included in the preset list, displaying, on the second display, the information sent by the fourth terminal; or if detecting that a fourth terminal is in a screen-off state, and information sent by the fourth terminal includes information generated by a first application, displaying, on the second display, the information sent by the fourth terminal.

Therefore, in implementations of this application, when the terminal screens off and/or runs a specific program, the received information can be forwarded to the electronic device, so that the user can view, without opening the terminal, the information received by the terminal, thereby improving user experience.

In a possible implementation, the method further includes: obtaining sixth display data on the second display; and if detecting a drag operation on a window corresponding to the sixth display data, generating seventh display data based on the sixth display data, and displaying the seventh display data on the first display.

Therefore, in implementations of this application, the user can drag to adjust a ranking location of a display window on the second display, so that the display window on the second display is arranged based on the requirement of the user, thereby improving user experience.

In a possible implementation, the method may further include: obtaining historical data displayed on the first display in a preset time period; generating prompt data based on the historical data; and displaying the prompt data on the second display, where the prompt data is used to prompt an event generated in the historical data.

Therefore, in implementations of this application, the historical data of the user can be obtained, the event in the historical data can be extracted, and a prompt is displayed on the second display, so that the user can observe the historical data on the second display, thereby improving user experience.

In a possible implementation, the second display further includes a keyboard window, and the keyboard window displays a virtual keyboard.

In a possible implementation, the method further includes: if an operation of expanding the second window is detected, and the second window is any window displayed on the second display, closing the keyboard window, or reducing a size of the keyboard window, so that the expanded second window does not overlap the reduced keyboard window displayed on the second display.

Therefore, in implementations of this application, the virtual keyboard can be displayed on the second display, and the virtual keyboard can be adaptively adjusted or closed based on a size and a location of a window that needs to be displayed on the second display, so that the window displayed on the second display is more convenient for user's observation, thereby improving user experience.

According to a second aspect, this application provides an interface display method, applied to an electronic device. The electronic device includes a first display, and the method includes: sending a request message to a server, where the request message is used to request the server to send first information to a terminal; receiving second information sent by the terminal, where the second information includes the first information; and displaying the second information on the first display.

Therefore, in implementations of this application, the electronic device can send the request message to the server, to request the server to send the information to the terminal, and the terminal sends the information to the electronic device. For example, this is applied to a scenario in which an identity is verified for the electronic device. A user can view the verification message on the second display without opening the terminal, thereby improving user experience.

In a possible implementation, the displaying the second information on the first display includes: if detecting that the terminal is in a screen-off state, displaying, on the first display, information sent by a fourth terminal, where the fourth terminal is any one of at least one terminal; or if the second information includes information generated by a first application in the terminal, and the first application is an application included in a preset list, displaying the second information on the first display; or if detecting that the terminal is in a screen-off state, and the second information includes information generated by a second application, displaying the information sent by the terminal on the first display.

Therefore, in implementations of this application, when the terminal screens off and/or runs a specific program, the received information can be forwarded to the electronic device, so that the user can view, without opening the terminal, the information received by the terminal, thereby improving user experience.

According to a third aspect, this application provides an electronic device. The electronic device includes a first display, a second display, a memory, and one or more processors, the memory stores code of a graphical user interface of an application, and the one or more processors are configured to execute the code of the graphical user interface (GUI) stored in the memory, to display the graphical user interface on the first display or the second display; and the graphical user interface includes:
determining second display data based on first display data in response to an operation on a display window on the first display, where the first display data is data displayed in the display window on the first display, the second display data includes data corresponding to a selected control in the first display data, and the second display data is less than the first display data; and
displaying, on the second display, a window corresponding to the second display data.

In a possible implementation, the graphical user interface further includes: if the second display includes a plurality of display windows, in response to a slide operation on the plurality of display windows, selecting, on the second display based on the slide operation, a preset quantity of windows from the plurality of display windows for display, where the plurality of display windows do not overlap on the second display.

In a possible implementation, the operation on the display window corresponding to the first display data includes at least one of the following operations performed on the first display:
a drag operation, a close operation, a minimize operation, control selection, file selection, a play operation, a gesture operation, or a fold operation; and
the drag operation includes an operation of moving the display window after the display window is selected, the close operation is an operation of closing the display window, the minimize operation is an operation of hiding the display window, the control selection is an operation of selecting a control in the display window, the file selection is an operation of selecting a file displayed in the display window, the play operation is an operation of playing data displayed in the display window, the gesture operation is an operation formed by a gesture for controlling the display window, and the fold operation is adjusting an included angle between the first display and the second display.

In a possible implementation, if the operation on the display window corresponding to the first display data includes the drag operation, the determining second display data based on first display data includes: using at least one type of data in the first display data as the second display data; and the displaying, on the second display, a window corresponding to the second display data includes: determining a location, on the second display, of the display window of the second display data based on a location at which a cursor is released.

In a possible implementation, if the operation on the display window corresponding to the first display data includes the close operation or the minimize operation, the determining second display data based on first display data includes: scaling up or scaling down at least one type of data in the first display data, and/or deleting at least one type of data in the first display data, to obtain the second display data.

If the operation on the display window corresponding to the first display data includes the file selection, and a text in the display window is selected, the determining second display data based on first display data includes: using the selected text as the second display data; or translating the selected text, to obtain the second display data based on a translation result; or performing searching based on the selected text, to obtain the second display data based on a search result; or arranging the selected text, or obtaining an arrangement format corresponding to the selected text, to obtain the second display data; or if the selected text includes a value, performing exchange rate conversion on the value, to obtain the second display data.

If the operation on the display window corresponding to the first display data includes the file selection, and an image in the display window is selected, the determining second display data based on first display data includes: using the selected image as the second display data; or searching for a related image of the selected image, to obtain the second display data based on the related image; or performing target detection on the selected image, to obtain the second display data; or performing text recognition on the selected image, to obtain the second display data based on a recognized text.

If the operation on the display window corresponding to the first display data includes the play operation, the determining second display data based on first display data includes: obtaining, from the first display data, data related to a picture played on the first display, to obtain the second display data.

If the operation on the display window corresponding to the first display data includes the gesture operation, the determining second display data based on first display data includes: if detecting that the gesture corresponding to the gesture operation is a preset gesture, using at least one type of data in the first display data as the second display data.

In a possible implementation, if the operation on the display window corresponding to the first display data includes the fold operation, and the included angle between the first display and the second display is within a preset range, the determining second display data based on first display data includes: using the first display data as the second display data.

In a possible implementation, the displaying, on the second display, a window corresponding to the second display data includes: if detecting that a running application is an application in a preset list, or if detecting that the electronic device is in a preset mode, displaying, on the second display, the window corresponding to the second display data.

In a possible implementation, the GUI further includes:
in response to a click operation on a control in an interface of the application, obtaining fourth display data corresponding to the control clicked by the click operation, and replacing third display data displayed in an area corresponding to the first window with the fourth display data, where the first window is any window displayed on the second display.

In a possible implementation, a preset area on the second display includes at least one displayed preset window, and the at least one preset window displays at least one of a calendar, weather information, a trip record, a memo, or a note.

In a possible implementation, the GUI further includes: if detecting a drag operation on fifth display data displayed on the second display, using an area, corresponding to a location at which a cursor is released, on the second display as a display area of the fifth display data.

In a possible implementation, the GUI further includes: in response to obtaining information sent by at least one terminal, displaying, on the second display, the information sent by the at least one terminal.

In a possible implementation, the information sent by the at least one terminal includes data related to an application corresponding to the first display data.

In a possible implementation, the second display includes at least one window of a preset size that is arranged in a non-overlapping manner, and the GUI specifically includes: displaying, in the at least one window of the preset size that is arranged in the non-overlapping manner, the information sent by the at least one terminal.

In a possible implementation, the GUI specifically includes: obtaining information sent by a plurality of terminals, where the plurality of terminals include a first terminal and a second terminal; and displaying, in a second window on the second display, information sent by the first terminal; or
displaying, in the second window in response to a switch operation on the second window, information sent by the second terminal.

In a possible implementation, the obtaining information sent by at least one terminal includes: sending a request message to a server, to indicate the server to send a verification message to a third terminal, where the third terminal is any one of the at least one terminal; and receiving information sent by the third terminal, where the information sent by the third terminal includes the verification message.

In a possible implementation, the GUI includes:
if detecting that a fourth terminal is in a screen-off state, displaying, on the second display, information sent by the fourth terminal, where the fourth terminal is any one of the at least one terminal; or
if information sent by a fourth terminal includes information generated by a first application, and the first application is an application included in the preset list, displaying, on the second display, the information sent by the fourth terminal; or
if detecting that a fourth terminal is in a screen-off state, and information sent by the fourth terminal includes information generated by a first application, displaying, on the second display, the information sent by the fourth terminal.

In a possible implementation, the GUI further includes: obtaining sixth display data on the second display; and if detecting a drag operation on a window corresponding to the sixth display data, generating seventh display data based on the sixth display data, and displaying the seventh display data on the first display.

In a possible implementation, the GUI further includes: obtaining historical data displayed on the first display in a preset time period; generating prompt data based on the historical data; and displaying the prompt data on the second display, where the prompt data is used to prompt an event generated in the historical data.

In a possible implementation, the second display further includes a keyboard window, and the keyboard window displays a virtual keyboard.

In a possible implementation, the GUI further includes: in response to detecting an operation of expanding the second window, where the second window is any window displayed on the second display, closing the keyboard window, or reducing a size of the keyboard window, so that the expanded second window does not overlap the reduced keyboard window displayed on the second display.

According to a fourth aspect, this application further provides an electronic device. The electronic device includes a first display, a memory, and one or more processors, the memory stores code of a graphical user interface of an application, and the one or more processors are configured to execute the code of the graphical user interface (GUI) stored in the memory, to display the graphical user interface on the first display or a second display; and the graphical user interface includes: sending a request message to a server, where the request message is used to request the server to send first information to a terminal; receiving second information sent by the terminal, where the second information includes the first information; and displaying the second information on the first display.

In a possible implementation, the displaying the second information on the first display includes:
if detecting that the terminal is in a screen-off state, displaying, on the first display, information sent by the fourth terminal, where the fourth terminal is any one of the at least one terminal; or
if the second information includes information generated by a first application in the terminal, and the first application is an application included in a preset list, displaying the second information on the first display; or
if detecting that the terminal is in a screen-off state, and the second information includes information generated by the second application, displaying, on the first display, information sent by the terminal.

According to a fifth aspect, this application provides an interface display apparatus, used in an electronic device. The electronic device includes a first display and a second display, the first display is electrically connected to the second display, and the apparatus includes:
a generation module, configured to determine second display data based on first display data in response to an operation on a display window on the first display, where the first display data is data displayed in the display window on the first display, the second display data includes data corresponding to a selected control in the first display data, and the second display data is less than the first display data; and
a display module, configured to display, on the second display, a window corresponding to the second display data.

In a possible implementation, the display module is further configured to: if the second display includes a plurality of display windows, in response to a slide operation on the plurality of display windows, select, on the second display based on the slide operation, a preset quantity of windows from the plurality of display windows for display, where the plurality of display windows do not overlap on the second display.

In a possible implementation, the operation on the display window corresponding to the first display data includes at least one of the following operations performed on the first display:
a drag operation, a close operation, a minimize operation, control selection, file selection, a play operation, a gesture operation, or a fold operation; and
the drag operation includes an operation of moving the display window after the display window is selected, the close operation is an operation of closing the display window, the minimize operation is an operation of hiding the display window, the control selection is an operation of selecting a control in the display window, the file selection is an operation of selecting a file displayed in the display window, the play operation is an operation of playing data displayed in the display window, the gesture operation is an operation formed by a gesture for controlling the display window, and the fold operation is adjusting an included angle between the first display and the second display.

In a possible implementation, if the operation on the display window corresponding to the first display data includes the drag operation, the display module is further configured to use at least one type of data in the first display data as the second display data.

The display module is further configured to determine a location, on the second display, of the display window of the second display data based on a location at which a cursor is released.

In a possible implementation, if the operation on the display window corresponding to the first display data includes the close operation or the minimize operation, the display module is specifically configured to scale up or scale down at least one type of data in the first display data, and/or delete at least one type of data in the first display data, to obtain the second display data.

In a possible implementation, if the operation on the display window corresponding to the first display data includes the file selection, and a text in the display window is selected, the display module is specifically configured to: use the selected text as the second display data; or translate the selected text, to obtain the second display data based on a translation result; or perform searching based on the selected text, to obtain the second display data based on a search result; or arrange the selected text, or obtain an arrangement format corresponding to the selected text, to obtain the second display data; or if the selected text includes a value, perform exchange rate conversion on the value, to obtain the second display data.

In a possible implementation, if the operation on the display window corresponding to the first display data includes the file selection, and an image in the display window is selected, the display module is specifically configured to: use the selected image as the second display data; or search for a related image of the selected image, to obtain the second display data based on the related image; or perform target detection on the selected image, to obtain the second display data; or perform text recognition on the selected image, to obtain the second display data based on a recognized text.

In a possible implementation, if the operation on the display window corresponding to the first display data includes the play operation, the display module is specifically configured to: obtain, from the first display data, data related to a picture played on the first display, to obtain the second display data.

In a possible implementation, if the operation on the display window corresponding to the first display data includes the gesture operation, the generation module is specifically configured to: if detecting that the gesture corresponding to the gesture operation is a preset gesture, use at least one type of data in the first display data as the second display data.

In a possible implementation, if the operation on the display window corresponding to the first display data includes the fold operation, and the included angle between the first display and the second display is within a preset range, the generation module is specifically configured to use the first display data as the second display data.

In a possible implementation, the display module is specifically configured to: if detecting that a running application is an application in a preset list, or if detecting that the electronic device is in a preset mode, display, on the second display, the window corresponding to the second display data.

In a possible implementation, a first window on the second display includes third display data, the third display data includes an interface of an application, and the display module is further configured to: in response to a click operation on a control in the interface of the application, obtain fourth display data corresponding to the control click by the click operation, and replace the third display data displayed in an area corresponding to the first window with the fourth display data, where the first window is any window displayed on the second display.

In a possible implementation, a preset area on the second display includes at least one displayed preset window, and the at least one preset window displays at least one of a calendar, weather information, a trip record, a memo, or a note.

In a possible implementation, the display module is further configured to: if detecting a drag operation on fifth display data displayed on the second display, use an area, corresponding to a location at which a cursor is released, on the second display as a display area of the fifth display data.

In a possible implementation, the display module is further configured to: obtain information sent by at least one terminal, and display, on the second display, the information sent by the at least one terminal.

In a possible implementation, the information sent by the at least one terminal includes data related to an application corresponding to the first display data.

In a possible implementation, the second display includes at least one window of a preset size that is arranged in a non-overlapping manner, and the display module is further configured to display, in the at least one window of the preset size that is arranged in the non-overlapping manner, the information sent by the at least one terminal.

In a possible implementation, the display module is further configured to: obtain information sent by a plurality of terminals, where the plurality of terminals include a first terminal and a second terminal; display, in a second window on the second display, information sent by the first terminal; and display, in the second window in response to a switch operation on the second window, information sent by the second terminal.

In a possible implementation, the display module is further configured to: send a request message to a server, to indicate the server to send a verification message to a third terminal, where the third terminal is any one of the at least one terminal; and receive information sent by the third terminal, where the information sent by the third terminal includes the verification message.

In a possible implementation, the display module is further configured to: if detecting that a fourth terminal is in a screen-off state, display, on the second display, information sent by the fourth terminal, where the fourth terminal is any one of the at least one terminal; or if information sent by a fourth terminal includes information generated by a first application, and the first application is an application included in the preset list, display, on the second display, the information sent by the fourth terminal; or if detecting that a fourth terminal is in a screen-off state, and information sent by the fourth terminal includes information generated by a first application, display, on the second display, the information sent by the fourth terminal.

In a possible implementation, the display module is further configured to: obtain sixth display data on the second display; and if detecting a drag operation on a window corresponding to the sixth display data; generate seventh display data based on the sixth display data; and display the seventh display data on the first display.

In a possible implementation, the display module is further configured to: obtain historical data displayed on the first display in a preset time period; generate prompt data based on the historical data; and display the prompt data on the second display, where the prompt data is used to prompt an event generated in the historical data.

In a possible implementation, the second display further includes a keyboard window, and the keyboard window displays a virtual keyboard.

In a possible implementation, the display module is further configured to: if an operation of expanding the second window is detected, and the second window is any window displayed on the second display, close the keyboard window, or reduce a size of the keyboard window, so that the expanded second window does not overlap the reduced keyboard window displayed on the second display.

According to a sixth aspect, this application provides an interface display apparatus, used in an electronic device. The electronic device includes a first display, and the apparatus includes:
a transceiver module, configured to send a request message to a server, where the request message is used to request the server to send first information to a terminal, where
the transceiver module is further configured to receive second information sent by the terminal, and the second information includes the first information; and
a display module, configured to display the second information on the first display.

In a possible implementation, the display module is specifically configured to:
if detecting that the terminal is in a screen-off state, display, on the first display, information sent by the fourth terminal, where the fourth terminal is any one of the at least one terminal; or
if the second information includes information generated by a first application in the terminal, and the first application is an application included in a preset list, display the second information on the first display; or
if detecting that the terminal is in a screen-off state, and the second information includes information generated by a second application, display, on the first display, information sent by the terminal.

According to a seventh aspect, an embodiment of this application provides an electronic device, including a processor and a memory. The processor and the memory are interconnected through a line, and the processor invokes program code in the memory, to perform a processing-related function in the interface display method according to any implementation of the first aspect. Optionally, the electronic device may be a chip.

According to an eighth aspect, an embodiment of this application provides an electronic device, including a processor and a memory. The processor and the memory are interconnected through a line, and the processor invokes program code in the memory, to perform a processing-related function in the interface display method according to any implementation of the second aspect. Optionally, the electronic device may be a chip.

According to a ninth aspect, an embodiment of this application provides an electronic device. The electronic device may also be referred to as a digital processing chip or a chip. The chip includes a processing unit and a communication interface. The processing unit obtains program instructions through the communication interface, and the program instructions are executed by the processing unit, so that the processing unit is configured to perform a processing-related function according to any optional implementation of the first aspect or the second aspect.

According to a tenth aspect, an embodiment of this application provides a computer-readable storage medium, including instructions. When the instructions are run on a computer, the computer is enabled to perform the method according to any optional implementation of the first aspect or the second aspect.

According to an eleventh aspect, an embodiment of this application provides a computer program product including instructions. When the computer program product runs on a computer, the computer is enabled to perform the method according to any two of the first aspect or any optional implementation of the first aspect.

### BRIEF DESCRIPTION OF THE DRAWINGS

FIG. 1 is a schematic diagram of a network architecture according to this application;

FIG. 2 is a schematic diagram of a structure of an electronic device according to this application;

FIG. 3 is a schematic diagram of a structure of another electronic device according to this application;

FIG. 4 is a schematic diagram of a structure of another electronic device according to this application;

FIG. 5 is a schematic diagram of a structure of another electronic device according to this application;

FIG. 6 is a schematic diagram of a structure of another electronic device according to this application;

FIG. 7 is a schematic diagram of a structure of another electronic device according to this application;

FIG. 8 is a schematic flowchart of an interface display method according to this application;

FIG. 9 is a schematic diagram of a structure of another electronic device according to this application;

FIG. 10 is a schematic diagram of a GUI according to this application;

FIG. 11 is a schematic diagram of another GUI according to this application;

FIG. 12 is a schematic diagram of another GUI according to this application;

FIG. 13 is a schematic diagram of another GUI according to this application;

FIG. 14 is a schematic diagram of another GUI according to this application;

FIG. 15 is a schematic diagram of another GUI according to this application;

FIG. 16 is a schematic diagram of another GUI according to this application;

FIG. 17 is a schematic flowchart of another interface display method according to this application;

FIG. 18 is a schematic diagram of another GUI according to this application;

FIG. 19 is a schematic diagram of another GUI according to this application;

FIG. 20 is a schematic flowchart of another interface display method according to this application;

FIG. 21 is a schematic diagram of another GUI according to this application;

FIG. 22 is a schematic diagram of another GUI according to this application;

FIG. 23 is a schematic diagram of another GUI according to this application;

FIG. 24 is a schematic diagram of another GUI according to this application;

FIG. 25 is a schematic diagram of another GUI according to this application;

FIG. 26 is a schematic diagram of another GUI according to this application;

FIG. 27 is a schematic diagram of another GUI according to this application;

FIG. 28 is a schematic diagram of another GUI according to this application;

FIG. 29 is a schematic diagram of another GUI according to this application;

FIG. 30 is a schematic diagram of another GUI according to this application;

FIG. 31 is a schematic diagram of a structure of another electronic device according to this application;

FIG. 32 is a schematic diagram of another GUI according to this application;

FIG. 33 is a schematic diagram of another GUI according to this application;

FIG. 34 is a schematic diagram of another GUI according to this application;

FIG. 35 is a schematic diagram of another GUI according to this application;

FIG. 36 is a schematic diagram of another GUI according to this application;

FIG. 37 is a schematic diagram of another GUI according to this application;

FIG. 38 is a schematic diagram of another GUI according to this application;

FIG. 39 is a schematic diagram of another GUI according to this application;

FIG. 40 is a schematic diagram of another GUI according to this application;

FIG. 41 is a schematic diagram of another GUI according to this application;

FIG. 42 is a schematic diagram of another GUI according to this application;

FIG. 43 is a schematic diagram of another GUI according to this application;

FIG. 44 is a schematic diagram of another GUI according to this application;

FIG. 45 is a schematic flowchart of another interface display method according to this application;

FIG. 46 is a schematic diagram of another GUI according to this application;

FIG. 47 is a schematic diagram of a structure of an interface display apparatus according to this application;

FIG. 48 is a schematic diagram of a structure of another interface display apparatus according to this application; and

FIG. 49 is a schematic diagram of a structure of another electronic device according to this application.

### DETAILED DESCRIPTION OF ILLUSTRATIVE EMBODIMENTS

The following describes technical solutions in embodiments of this application with reference to the accompanying drawings in embodiments of this application. It is clear that the described embodiments are merely some rather than all of embodiments of this application. All other embodiments obtained by a person skilled in the art based on embodiments of this application without creative efforts shall fall within the protection scope of this application.

First, a method provided in this application is applied to various electronic devices. The electronic device has a display or is connected to a display.

The electronic device in this application may include but is not limited to: an intelligent mobile phone, a television, a tablet computer, a wristband, a head-mounted display device (Head Mount Display, HMD), an augmented reality (augmented reality, AR) device, a mixed reality (mixed reality, MR) device, a cellular phone (cellular phone), a smartphone (smartphone), a personal digital assistant (personal digital assistant, PDA), a tablet computer, an in-vehicle terminal, a laptop computer (laptop computer) (or referred to as a notebook computer or a laptop computer), a personal computer (personal computer, PC), and the like. Certainly, in the following embodiments, a specific form of the electronic device is not limited.

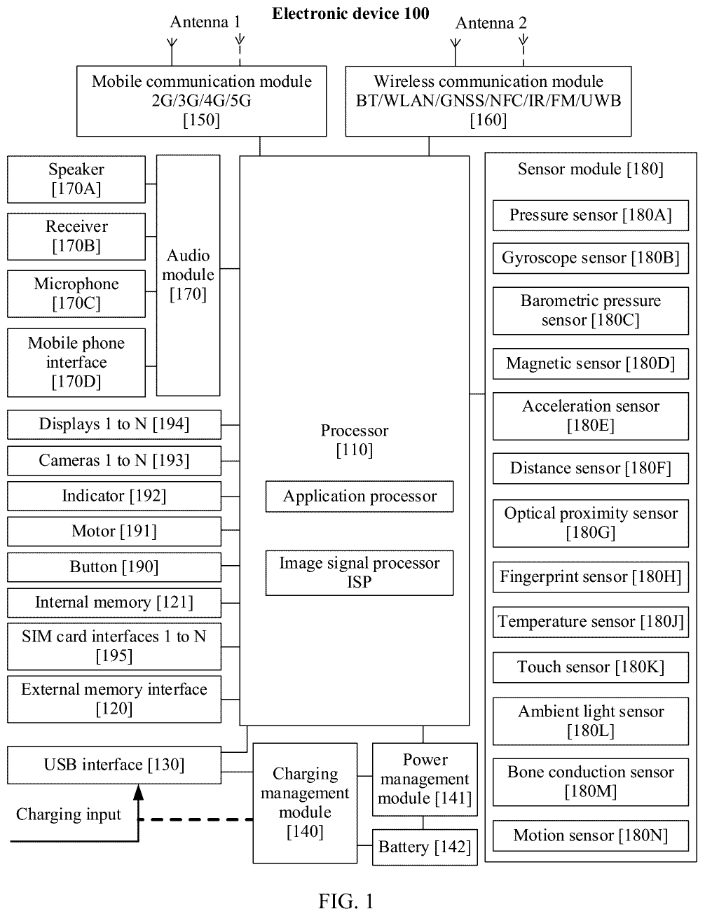

For example, refer to FIG. 1. The following uses a specific structure as an example to describe a structure of an electronic device provided in this application.

The electronic device 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, a motion sensor 180N, and the like.

It may be understood that the structure shown in this embodiment of this application does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural-network processing unit (neural-network processing unit, NPU), and/or the like. Different processing units may be independent components, or may be integrated into one or more processors.

The controller may generate an operation control signal based on an instruction operation code and a time sequence signal, to complete control of instruction fetching and instruction execution.

A memory may be disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The I2C interface is a bidirectional synchronization serial bus, and includes a serial data line (serial data line, SDA) and a serial clock line (derail clock line, SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transfer an audio signal to the wireless communication module 160 through the I2S interface, to implement a function of answering a call through a Bluetooth headset.

The PCM interface may also be configured to perform audio communication, and sample, quantize, and code an analog signal. In some embodiments, the audio module 170 may be coupled to the wireless communication module 160 through a PCM bus interface. In some embodiments, the audio module 170 may also transfer an audio signal to the wireless communication module 160 through the PCM interface, to implement a function of answering a call through a Bluetooth headset. Both the I2S interface and the PCM interface may be used for audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transfer an audio signal to the wireless communication module 160 through the UART interface, to implement a function of playing music through a Bluetooth headset.

The MIPI interface may be configured to connect the processor 110 to a peripheral component like the display 194 or the camera 193. The MIPI interface includes a camera serial interface (camera serial interface, CSI), a display serial interface (display serial interface, DSI), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, or the like. The GPIO interface may alternatively be configured as an I2C interface, an I2S interface, a UART interface, an MIPI interface, or the like.

The USB interface 130 is an interface that conforms to a USB standard specification, and may be specifically a mini USB interface, a micro USB interface, a USB type-C interface, or the like. The USB interface 130 may be configured to connect to a charger to charge the electronic device 100, or may be configured to transmit data between the electronic device 100 and a peripheral device, or may be configured to connect to a headset for playing audio through the headset. The interface may be configured to connect to another electronic device like an AR device. It should be understood that, the USB interface 130 herein may also be replaced with another interface, for example, an interface that may implement charging or data transmission, such as a type-c interface or a lighting interface. The USB interface 130 herein is merely used as an example for description.

It may be understood that an interface connection relationship between the modules that is shown in this embodiment of the present invention is merely an example for description, and does not constitute a limitation on a structure of the electronic device 100. In some other embodiments of this application, the electronic device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some embodiments of wired charging, the charging management module 140 may receive a charging input of a wired charger through the USB interface 130. In some embodiments of wireless charging, the charging management module 140 may receive a wireless charging input through a wireless charging coil of the electronic device 100. The charging management module 140 supplies power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to receive and transmit an electromagnetic wave signal. Each antenna in the electronic device 100 may be configured to cover one or more communication frequency bands. Different antennas may be multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a solution, applied to the electronic device 100, to wireless communication including 2G, 3G, 4G, 5G, and the like. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules of the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transfers the low-frequency baseband signal obtained through demodulation to the baseband processor for processing. The low-frequency baseband signal is processed by the baseband processor and then transferred to the application processor. The application processor outputs a sound signal by an audio device (which is not limited to the speaker 170A, the receiver 170B, or the like), or displays an image or a video on the display 194. In some embodiments, the modem processor may be an independent component. In some other embodiments, the modem processor may be independent of the processor 110, and is disposed in a same device as the mobile communication module 150 or another functional module.

The wireless communication module 160 may provide a solution, applied to the electronic device 100, to wireless communication including a wireless local area network (wireless local area networks, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, ultra-wideband (ultra-wide band, UWB), an infrared (infrared, IR) technology, or the like. The wireless communication module 160 may be one or more components integrating at least one communication processor module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, in the electronic device 100, the antenna 1 and the mobile communication module 150 are coupled, and the antenna 2 and the wireless communication module 160 are coupled, so that the electronic device 100 can communicate with a network and another device by using a wireless communication technology. The wireless communication technology may include but is not limited to a 5th-generation mobile communication technology (5th-Generation, 5G) system, a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), Bluetooth (Bluetooth), a global navigation satellite system (the global navigation satellite system, GNSS), wireless fidelity (wireless fidelity, Wi-Fi), near field communication (near field communication, NFC), FM (may also be referred to as frequency modulation), Zigbee (Zigbee), a radio frequency identification (radio frequency identification, RFID) technology, an infrared (infrared, IR) technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation systems, SBAS).

In some implementations, the electronic device 100 may also include a wired communication module (which is not shown in FIG. 1), or the mobile communication module 150 or the wireless communication module 160 herein may be replaced with a wired communication module (which is not shown in FIG. 1). The wired communication module may enable the electronic device to communicate with another device by using a wired network. The wired network may include but is not limited to one or more of the following: an optical transport network (optical transport network, OTN), a synchronous digital hierarchy (synchronous digital hierarchy, SDH), a passive optical network (passive optical network, PON), the Ethernet (Ethernet), the flexible Ethernet (flexible Ethernet, FlexE), or the like.

The electronic device 100 may implement a display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, and execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini-LED, a micro-LED, a micro-OLED, a quantum dot light emitting diode (quantum dot light emitting diode, QLED), or the like. In some embodiments, the electronic device 100 may include one or N displays 194, where N is a positive integer greater than 1.

The electronic device 100 may implement a photographing function through the ISP, the camera 193, the video codec, the GPU, the display 194, the application processor, and the like.

The ISP is configured to process data fed back by the camera 193. For example, during photographing, a shutter is pressed, and light is transferred to a photosensitive element of the camera through a lens. An optical signal is converted into an electrical signal, and the photosensitive element of the camera transfers the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge-coupled device (charge-coupled device, CCD) or a complementary metal-oxide-semiconductor (complementary metal-oxide-semiconductor, CMOS) phototransistor. The photosensitive element converts an optical signal into an electrical signal, and then transfers the electrical signal to the ISP to convert the electrical signal into a digital image signal. The ISP outputs the digital image signal to the DSP for processing. The DSP converts the digital image signal into an image signal in a standard format, for example, RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The video codec is configured to compress or decompress a digital video. The electronic device 100 may support one or more video codecs. In this way, the electronic device 100 can play back or record videos in a plurality of coding formats, for example, moving picture experts group (moving picture experts group, MPEG)-1, MPEG-2, MPEG-3, and MPEG-4.

The NPU is a neural-network (neural-network, NN) computing processor, and simulates a biological neural network structure like a transmission mode between neurons in a human brain to perform rapid processing on input information, and can perform continuous self-learning. Applications such as intelligent cognition of the electronic device 100 may be implemented through the NPU, for example, image recognition, facial recognition, speech recognition, and text understanding.

The external memory interface 120 may be used to connect to an external storage card, for example, a micro SD card, to extend a storage capability of the electronic device 100. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, or may include a nonvolatile memory, for example, at least one magnetic disk storage device, a flash memory, or a universal flash storage (universal flash storage, UFS). The processor 110 runs instructions stored in the internal memory 121 and/or instructions stored in the memory disposed in the processor, to perform various function applications and data processing of the electronic device 100.

The electronic device 100 may implement an audio function, for example, music playing or recording, by using the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The audio module 170 may be configured to code and decode an audio signal. In some embodiments, the audio module 170 may be disposed in the processor 110, or some functional modules in the audio module 170 are disposed in the processor 110.

The speaker 170A, also referred to as a “loudspeaker”, is configured to convert an audio electrical signal into a sound signal. The electronic device 100 may be used to listen to music or answer a call in a hands-free mode over the speaker 170A.

The receiver 170B, also referred to as an “earpiece”, is configured to convert an audio electrical signal into a sound signal. When a call is answered or voice information is received through the electronic device 100, the receiver 170B may be put close to a human ear to listen to a voice.

The microphone 170C, also referred to as a “mike” or a “mic”, is configured to convert a sound signal into an electrical signal. When making a call or sending voice information, a user may make a sound near the microphone 170C through the mouth of the user, to input a sound signal to the microphone 170C. At least one microphone 170C may be disposed in the electronic device 100. In some other embodiments, two microphones 170C may be disposed in the electronic device 100, to collect a sound signal and implement a noise reduction function. In some other embodiments, three, four, or more microphones 170C may alternatively be disposed in the electronic device 100, to collect a sound signal, implement noise reduction, and identify a sound source, so as to implement a directional recording function, and the like.

The headset jack 170D is configured to connect to a wired headset. The headset jack 170D may be a USB interface 130, or may be a 3.5 mm open mobile terminal platform (open mobile terminal platform, OMTP) standard interface or cellular telecommunications industry association of the USA (cellular telecommunications industry association of the USA, CTIA) standard interface.

The pressure sensor 180A is configured to sense a pressure signal, and can convert the pressure signal into an electrical signal. In some embodiments, the pressure sensor 180A may be disposed on the display 194. There are a plurality of types of pressure sensors 180A, such as a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The electronic device 100 determines pressure intensity based on a change in the capacitance. When a touch operation is performed on the display 194, the electronic device 100 detects intensity of the touch operation through the pressure sensor 180A. The electronic device 100 may also calculate a touch location based on a detection signal of the pressure sensor 180A. In some embodiments, touch operations that are performed in a same touch position but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating an SMS message is performed.

The gyroscope sensor 180B may be configured to determine a moving posture of the electronic device 100. In some embodiments, an angular velocity of the electronic device 100 around three axes (namely, axes x, y, and z) may be determined through the gyroscope sensor 180B. The gyroscope sensor 180B may be configured to implement image stabilization during photographing. For example, when the shutter is pressed, the gyroscope sensor 180B detects an angle at which the electronic device 100 jitters, calculates, based on the angle, a distance for which a lens module needs to compensate, and allows the lens to cancel the jitter of the electronic device 100 through reverse motion, to implement image stabilization. The gyroscope sensor 180B may also be used in a navigation scenario and a somatic game scenario.

The barometric pressure sensor 180C is configured to measure barometric pressure. In some embodiments, the electronic device 100 calculates an altitude through the barometric pressure measured by the barometric pressure sensor 180C, to assist in positioning and navigation.

The magnetic sensor 180D includes a Hall sensor. The electronic device 100 may detect opening and closing of a flip cover by using the magnetic sensor 180D. In some embodiments, when the electronic device 100 is a clamshell phone, the electronic device 100 may detect opening and closing of a flip cover based on the magnetic sensor 180D. Further, a feature like automatic unlocking of the flip cover is set based on a detected opening or closing state of the leather case or a detected opening or closing state of the flip cover.

The acceleration sensor 180E may detect accelerations in various directions (usually on three axes) of the electronic device 100. When the electronic device 100 is still, a magnitude and a direction of gravity may be detected. The acceleration sensor 180E may be configured to identify a posture of the electronic device, and is used in an application such as switching between a landscape mode and a portrait mode or a pedometer.

The distance sensor 180F is configured to measure a distance. The electronic device 100 may measure the distance in an infrared manner or a laser manner. In some embodiments, in a photographing scenario, the electronic device 100 may measure a distance through the distance sensor 180F to implement quick focusing.

The optical proximity sensor 180G may include, for example, a light emitting diode (LED) and an optical detector, for example, a photodiode. The light emitting diode may be an infrared light emitting diode. The electronic device 100 emits infrared light by using the light-emitting diode. The electronic device 100 detects infrared reflected light from a nearby object through the photodiode. When sufficient reflected light is detected, it may be determined that there is an object near the electronic device 100. When insufficient reflected light is detected, the electronic device 100 may determine that there is no object near the electronic device 100. The electronic device 100 may detect, by using the optical proximity sensor 180G, that the user holds the electronic device 100 close to an ear for a call, to automatically turn off a screen for power saving. The optical proximity sensor 180G may also be used in a smart cover mode or a pocket mode to automatically perform screen unlocking or locking.

The ambient light sensor 180L is configured to sense ambient light brightness. The electronic device 100 may adaptively adjust brightness of the display 194 based on the sensed ambient light brightness. The ambient light sensor 180L may be configured to automatically adjust white balance during photographing. The ambient light sensor 180L may also cooperate with the optical proximity sensor 180G to detect whether the electronic device 100 is in a pocket, to avoid an accidental touch.

The fingerprint sensor 180H is configured to collect a fingerprint. The electronic device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the electronic device 100 executes a temperature processing policy through the temperature detected by the temperature sensor 180J. For example, when the temperature reported by the temperature sensor 180J exceeds a threshold, the electronic device 100 lowers performance of a processor nearby the temperature sensor 180J, to reduce power consumption for thermal protection. In some other embodiments, when the temperature is less than another threshold, the electronic device 100 heats the battery 142 to prevent the electronic device 100 from being shut down abnormally due to a low temperature. In some other embodiments, when the temperature is lower than still another threshold, the electronic device 100 boosts an output voltage of the battery 142 to avoid abnormal shutdown caused by a low temperature.

The touch sensor 180K is also referred to as a “touch component”. The touch sensor 180K may be disposed on the display 194, and the touch sensor 180K and the display 194 constitute a touchscreen, which is also referred to as a “touch screen”. The touch sensor 180K is configured to detect a touch operation performed on or near the touch sensor. The touch sensor may transfer the detected touch operation to the application processor to determine a type of the touch event. A visual output related to the touch operation may be provided on the display 194. In some other embodiments, the touch sensor 180K may also be disposed on a surface of the electronic device 100 at a location different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal. In some embodiments, the bone conduction sensor 180M may also be disposed in the headset, to obtain a bone conduction headset. The audio module 170 may obtain a voice signal through parsing based on the vibration signal that is of the vibration bone of the vocal-cord part and that is obtained by the bone conduction sensor 180M, to implement a voice function. The application processor may parse heart rate information based on the blood pressure beating signal obtained by the bone conduction sensor 180M, to implement a heart rate detection function.

The motion sensor 180N may be configured to: detect a moving object within a shooting range of a camera, and collect a moving contour, a moving trajectory, or the like of the moving object. For example, the motion sensor 180N may be an infrared sensor, a laser sensor, or a dynamic vision sensor (dynamic vision sensor, DVS). The DVS may specifically include a sensor like a DAVIS (Dynamic and Active-pixel Vision Sensor), an ATIS (Asynchronous Time-based Image Sensor), or a CeleX sensor. The DVS draws on a characteristic of biological vision. Each pixel simulates one neuron and independently responds to a relative change in light intensity (“light intensity” for short hereinafter). When the relative change in the light intensity exceeds a threshold, a pixel outputs an event signal, where the event signal includes a location of the pixel, a time stamp, and feature information of the light intensity.

The button 190 includes a power button, a volume button, and the like. The button 190 may be a mechanical button, or may be a touch button. The electronic device 100 may receive a key input, and generate a key signal input related to a user setting and function control of the electronic device 100.

The motor 191 may generate a vibration prompt. The motor 191 may be configured to provide an incoming call vibration prompt and a touch vibration feedback. For example, touch operations performed on different applications (for example, photographing and audio playing) may correspond to different vibration feedback effect. The motor 191 may also correspond to different vibration feedback effect for touch operations performed on different areas of the display 194. Different application scenarios (for example, a time reminder, information receiving, an alarm clock, and a game) may also correspond to different vibration feedback effect. Touch vibration feedback effect may be customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface 195 is also compatible with an external storage card. The electronic device 100 interacts with a network through the SIM card, to implement functions such as conversation and data communication. In some embodiments, the electronic device 100 uses an eSIM, that is, an embedded SIM card. The eSIM card may be embedded into the electronic device 100, and cannot be separated from the electronic device 100.

It should be noted that, in some actual application scenarios, the electronic device may include more or fewer components than those shown in FIG. 1. Specifically, a quantity of components may be adjusted based on an actual application scenario. This is not limited in this application.

The foregoing describes the example of the hardware structure of the electronic device provided in this application. A system that may be carried in the electronic device may include iOS®, Android®, Microsoft®, Linux®, HarmonyOS, or another operating system. This is not limited in embodiments of this application.

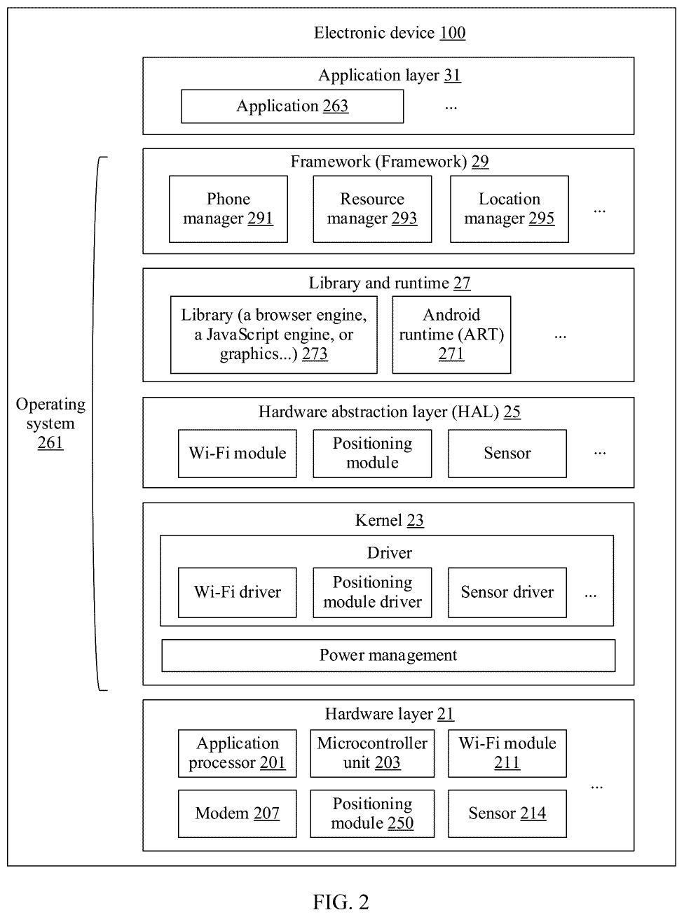

An electronic device 100 carrying an Android® operating system is used as an example. As shown in FIG. 2, the electronic device 100 may be logically divided into a hardware layer 21, an operating system 261, and an application layer 31. The hardware layer 21 includes hardware resources such as an application processor 201, a microcontroller unit 203, a modem 207, a Wi-Fi module 211, a sensor 214, and a positioning module 150. The application layer 31 includes one or more applications, for example, an application 263. The application 263 may be any type of application like a social application, an e-commerce application, or a browser, or may be an object searching app, so as to perform an interface display method provided in this application, for searching for a device that is lost by a user. The operating system 261 serves as software middleware between the hardware layer 21 and the application layer 31, and is a computer program for managing and controlling hardware and software resources.

In an embodiment, the operating system 261 includes a kernel 23, a hardware abstraction layer (hardware abstraction layer, HAL) 25, library and runtime (libraries and runtime) 27, and a framework (framework) 29. The kernel 23 is configured to provide an underlying system component and a service, for example, power management, memory management, thread management, or a hardware driver. The hardware driver includes a Wi-Fi driver, a sensor driver, a positioning module driver, and the like. The hardware abstraction layer 25 encapsulates a kernel driver, provides an interface for the framework 29, and shields implementation details of a lower layer. The hardware abstraction layer 25 runs in user space, and the kernel driver runs in kernel space.

The library and runtime 27 is also referred to as a runtime library, and provides a library file and an execution environment required by an executable program during running. The library and runtime 27 includes Android runtime (Android Runtime, ART) 271, library 273, and the like. The ART 271 is a virtual machine or a virtual machine instance that can convert bytecode of an application into machine code. The library 273 is a program library that provides support for the executable program during running, and includes a browser engine (for example, WebKit), a script execution engine (for example, a JavaScript engine), a graphics processing engine, and the like.

The framework 27 is configured to provide various basic common components and services, such as window management and location management, for an application in the application layer 31. The framework 27 may include a phone manager 291, a resource manager 293, a location manager 295, and the like.

All functions of the components in the operating system 261 described above may be implemented by the application processor 201 by executing programs stored in a memory 205.

A person skilled in the art may understand that the electronic device 100 may include fewer or more components than those shown in FIG. 2, and the electronic device shown in FIG. 2 includes only components more related to a plurality of implementations disclosed in embodiments of this application.

The electronic device may include one or more displays, or may be connected to one or more displays. When there are a plurality of displays, the plurality of displays may be disposed in the electronic device, or may be in communication connection to the electronic device, and the displays may be controlled by the electronic device. The following uses an example to describe a relationship between the electronic device and the display.

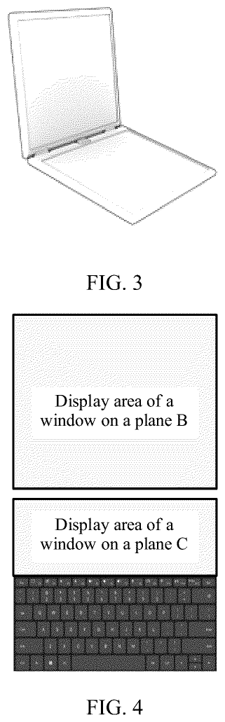

For example, as shown in FIG. 3, the electronic device may be a notebook computer. Two displays are disposed in the notebook computer, and are configured to perform independent display. There is usually an included angle between the two displays, and the included angle is usually adjustable. An input operation may be performed on the two displays by using a mouse, a stylus, or touching. Input manners of the two displays may be the same or may be different. For example, an input operation may be performed on a first display by using a mouse, and an input operation may be performed on a second display through touching. Certainly, in addition to two displays, more displays may be disposed. In this application, only the electronic device in which two displays are disposed is used as an example for description. Two displays mentioned below may be replaced with three or four displays. Specifically, a quantity of displays may be adjusted based on an actual application scenario. This is not limited in this application.

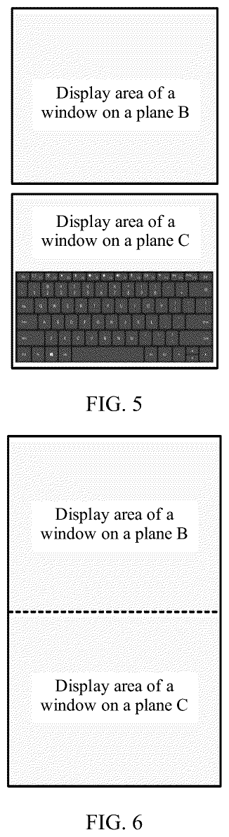

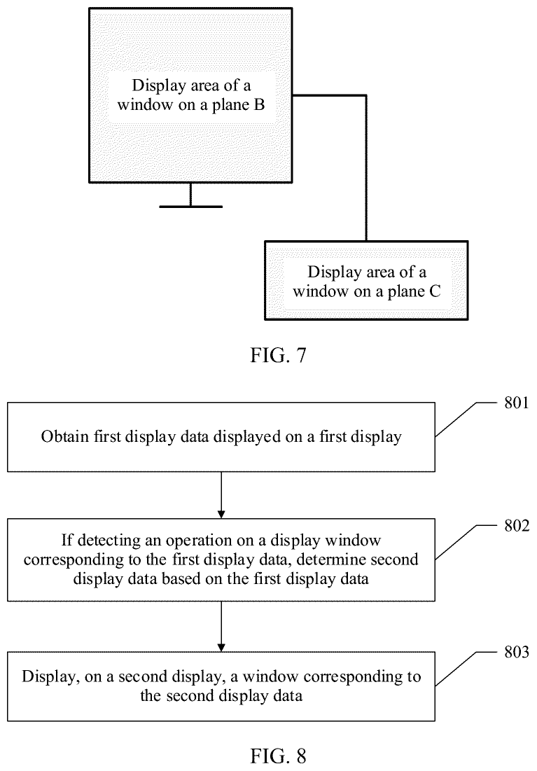

When two displays are configured for the electronic device, the two displays may be disposed in a plurality of manners. For example, the two displays are respectively referred to as a plane B (or referred to as a first display) and a plane C (or referred to as a second display) below. For example, as shown in FIG. 4, the electronic device may be configured with a physical keyboard, the plane B and the plane Care display areas, the physical keyboard is set to be parallel to the plane C, and the physical keyboard may be configured to perform input or control the electronic device. As shown in FIG. 5, the plane B and the plane C are display areas; and the plane C may be divided into a plurality of parts, where one part may be used to display various windows or data, another part may be used to display a virtual keyboard, and the virtual keyboard may be used by a user to perform input or control the electronic device, and may be usually scaled up or down or closed. For another example, as shown in FIG. 6, the plane B and the plane C are two parts of display areas in a same display; the two parts each may be used as a main display for display; and in this case the electronic device may include a foldable-screen mobile phone, a foldable-screen computer, or the like. For still another example, as shown in FIG. 7, the plane B and the plane C may be two connected displays, and specifically, a communication connection may be established through wireless or wired communication, for example, the plane B may be usually a display disposed separately, and the plane C may be an external touchscreen connected to the electronic device, like a mobile phone or a tablet.

The following describes a procedure of the method provided in this application with reference to the foregoing different setting manners of the electronic device and the display.

FIG. 8 is a schematic flowchart of an interface display method according to this application.

801: Obtain first display data displayed on a first display.

The first display may be one of a plurality of displays provided or connected to an electronic device, and may be configured to display data in the electronic device, such as an interface, a text, an image, or a video of an application, namely, the first display data.

It should be noted that the first display may have a plurality of display windows, for example, for displaying interfaces of a plurality of applications, displaying a plurality of frames of images, or displaying texts of a plurality of files. In this application, for example, the following uses one of the display windows as an example for description.

802: If detecting an operation on a display window corresponding to the first display data, determine second display data based on the first display data.

A user may control the electronic device in a manner of touching, a mouse, a button, or the like. When the operation performed by the user on the display window is detected, the second display data may be determined based on the first display data and a type of the operation.

The second display data may be data generated based on the first display data, or may be a part of the first display data. Manners of obtaining the second display data may be different in different scenarios or for different operation manners.

The second display data may include data corresponding to a selected control in the first display data, and for ease of viewing by the user, the second display data is less than the first display data.

A control, or referred to as a component, a widget, or a control, is a graphical user interface (GUI) element in a display window, information indicated by the control or an arrangement manner may be generally adjusted by a user, and the control may be, for example, a button, an image, or a text in the display window. The user may select the control by clicking, touching, or in another input manner, so as to implement man-machine interaction.

Generally, one display window may include one or more controls, or the entire window may be understood as a larger control, and includes a plurality of smaller controls.

The control mentioned in this step may include various controls in the display window on the first display, and the selected control may be understood to include a control corresponding to a location at which a cursor stays in a display interface or a control selected by the user.

Therefore, in implementations of this application, the second display data can be determined based on the first display data in response to the operation on the display window on the first display, and the second display data can be displayed on a second display. The second display data includes the data corresponding to the selected control in the first display data, and is less than the first display data, so that a more simplified window can be displayed on the second display, thereby facilitating a user operation and improving user experience.

Specifically, the operation on the window displayed on the first display may specifically include a plurality of types. For example, the operation may specifically include one or more of the following: a drag operation, a close operation, a minimize operation, control selection, file selection, a play operation, a gesture operation, or a fold operation.

The drag operation is an operation of dragging the display window after the display window is selected.

The close operation is an operation of closing the display window on the first display.

The minimize operation is an operation of hiding the display window on the first display, for example, an application corresponding to the display window is run in the background.

The control selection operation is an operation of selecting a control in the display window. For example, if the display window is a window for displaying chat software, a display interface of the chat software has a plurality of controls, such as a screenshot, jitter window, message sending, or font switching control, and the user may select the control by using a mouse or by touching.

The file selection is selecting a file in the display window, where the file may include data such as a text, a video, and an image.

The play operation is an operation of playing selected data, for example, playing a video, playing a voice, or playing a slide.

The fold operation is an operation of folding the first display and the second display, and may adjust an included angle between the first display and the second display.

In addition, the foregoing operations are merely examples for description. In an actual application scenario, there may be different operation manners in different application scenarios or different devices, and the operation manners may be specifically determined based on an actual application scenario. This is not limited in this application.

In a possible implementation, if the operation on the display window corresponding to the first display data includes the drag operation, at least one type of data in the first display data may be used as the first display data; and then a location, on the second display, of the display window corresponding to the second display data is determined based on a location at which a cursor is released. Therefore, in implementations of this application, the user can drag, by using the drag operation, a window displayed on the plane B to the plane C for display, and an operation is convenient, thereby improving user experience.

In a possible implementation, if the operation on the display window corresponding to the first display data includes the close operation or the minimize operation, at least one type of data in the first display data may be scaled up or scaled down, and/or at least one type of data in the first display data is deleted, to obtain the second display data. Therefore, in implementations of this application, after a window on the plane B is closed or minimized, all or a part of data in the window can be scaled up or down, or a part of data can be deleted, to obtain a more simplified window for display on the plane C, thereby improving user experience. Especially, when the plane B is inconvenient to display, the user can watch content displayed on the plane C, thereby improving user experience.

In addition, the at least one type of data in the first display data may be the data corresponding to the selected control. For example, if the first display data is a window of chat software that is being used by the user, a part of data may be selected from the first display data, for example, window data corresponding to a current chat object, or data corresponding to a control on which a cursor stays, as the second display data. Therefore, in implementations of this application, when the window on the plane B is transferred to the plane C for display, a part that is currently focused by the user can be transferred, so that a simpler interface that meets a user requirement can be displayed on the plane C, thereby improving user experience.

In a possible implementation, if the operation on the window corresponding to the first display data includes the file selection, the second display data may be obtained based on the selected file. Specifically, the selected file may include data such as an image, a text, a video, or audio.

Optionally, if the text displayed in the display window is selected, the selected text may be directly used as the second display data; or the selected text is translated, to obtain the second display data based on a translation result; or the selected text is searched for, to obtain the second display data based on a search result; or the selected text is rearranged, to obtain the second display data; or an arrangement format corresponding to the selected text is searched for, to obtain the second display data; or if the selected text includes a value, exchange rate conversion may be performed on the value, to obtain the second display data.

Therefore, in implementations of this application, further display, searching, rearrangement, exchange rate conversion, or the like may be performed on the text selected by the user, so that selection of the user can be fed back in time, to adapt to various scenarios, thereby improving user experience.

Optionally, if the image displayed in the display window is selected, the selected image may be directly used as the second display data; or a related image of the selected image may be searched for, to obtain the second display data based on the related image; or target detection is performed on the selected image, and a detection result is used as the second display data; or text recognition is performed on the selected image, to obtain the second display data based on a recognized text.

Therefore, in implementations of this application, further display, searching, detection, recognition, or the like may be performed on the image selected by the user, so that the image selected by the user can be fed back in time, thereby improving user experience.

In a possible implementation, if the operation on the window corresponding to the first display data includes the play operation, data related to a picture played on the first display may be obtained from the first display data, to obtain the second display data. For example, if the first display data is video data, and one frame of the video data is currently played on the first display, an image of the current frame may be obtained, and an operation like display, searching, detection, or recognition is further performed on the image. For another example, if the first display data includes a slide, a note corresponding to one page that is currently played may be obtained. To be specific, when the slide is played on the plane B, the plane C may display the note related to the currently played image, thereby improving user experience.

In a possible implementation, if the operation corresponding to the first display data includes the gesture operation, and when a gesture corresponding to the gesture operation is detected as a preset gesture, the second display data may be determined based on the first display data. For example, a part or all of data in the first display data is used as the second display data, or all or a part of data in the first display data is further processed to obtain the second display data.

In a possible implementation, when the fold operation is detected, and the included angle between the first display and the second display is within a preset range, the first display data is used as the second display data. It may be understood that the electronic device may be a foldable device. When the electronic device is folded, and the included angle between the plane B and the plane C is within the preset range, content displayed on the plane B may be transferred to the plane C for display, so that when a form of the electronic device is changed, displayed content can continue to be displayed, thereby improving user experience.

803: Display, on the second display, a window corresponding to the second display data.

After the second display data is obtained, the second display data may be displayed on the second display.

Windows displayed on the second display do not overlap, so that the second display data can be more complete, and the user can perform interaction in the complete display window, thereby improving user experience.

In addition, if there are a plurality of display windows on the second display, after a slide operation on the plurality of display windows is detected, a preset quantity of windows may be selected from the plurality of display windows based on the slide operation for display. The preset quantity may be determined based on a size of a display area of the second display or each display window. If the display area of the second display is larger or a size of the display window is smaller, the quantity of windows that can be displayed on the second display is larger; or if the display area of the second display is smaller or a size of the display window is larger, the quantity of windows that can be displayed on the second display is smaller. The slide operation may be sliding performed by the user by using a mouse, or may be sliding performed by using a touch, and may be specifically adjusted based on an actual application scenario.

Therefore, in implementations of this application, when there are a plurality of display windows, the plurality of display windows are not stacked, so that the user can view the complete windows. In addition, the user can view the plurality of windows by using the slide operation, so that the user can perform an operation on the plane C more conveniently, and more windows can be displayed in a limited display area, thereby improving user experience.

Optionally, the display window on the second display is an interaction window. For example, one of the windows is referred to as a first window for ease of differentiation. The first window displays third display data, and the third display data includes an interface of an application. In response to a click operation on a control in the interface of the application, fourth display data corresponding to the control clicked in the click operation is obtained, and content displayed in the first window is replaced with the fourth display data. For example, when the user clicks a displayed application on the plane C, if one of the controls is clicked, the window may be switched to an interface corresponding to the control, to complete response to the user operation, so that the user can perform an interaction operation on the plane C more conveniently.

Optionally, a preset area on the second display may include one or more displayed preset windows, and the plurality of preset windows display one or more pieces of common information such as a calendar, weather information, a trip record, a memo, or a note. It may be understood that one or more resident windows may be set on the second display, and some common information such as a calendar, weather, a trip, a memo, or a note is stored, so as to remind the user in time, thereby improving user experience.

Optionally, a display area in which each window is located may also be adjusted by using a drag operation on the window on the second display. If a drag operation on fifth display data displayed on the second display is detected, a display area corresponding to a location at which a cursor is released is used as a new display area of the fifth display area, that is, the fifth display data is displayed in the new display area. Therefore, the user can drag to adjust a display location of each window on the second display, thereby improving user experience.

Optionally, data sent by another device may be received and displayed on the second display. For example, information sent by one or more terminals may be obtained, and the information sent by the one or more terminals is displayed on the second display. The information sent by the one or more terminals may include an interface of the terminal, information received by the terminal, notification information sent by the terminal to the electronic device, or the like, and may be specifically adjusted based on an actual application scenario. Therefore, in implementations of this application, the information sent by the terminal, such as the interface of the terminal, the received information, or the information exchanged between the terminal and the electronic device, can be displayed on the second display, so that the user can interact with the terminal by using the electronic device, without opening the terminal, thereby improving user experience.

In a possible implementation, the information sent by the one or more terminals may include data related to an application corresponding to the first display data displayed on the electronic device. For example, the user may open, in the electronic device, a web page provided by a platform, and an application provided by the platform may be installed in the terminal. When the user opens the web page in the electronic device, the terminal may send, to the electronic device, information in the application that is locally run, for display on the plane C, so that the user can use the electronic device more conveniently, thereby improving user experience. In a possible implementation, the second display includes one or more windows of a preset size that are arranged in a non-overlapping manner, where the widows may be referred to as card windows. The received information sent by the one or more terminals may be displayed in the card windows, so that the non-overlapping card windows with clear typesetting display the information sent by the terminals, thereby facilitating user observation and improving user experience.

In a possible implementation, when information sent by a plurality of terminals is received, information sent by one (for ease of distinguishing, referred to as a first terminal) of the terminals may be displayed in a second window on the plane C, and a switch control is set in the second window. When a switch operation on the second window is detected, information sent by a second terminal may be displayed in the second window. Therefore, in implementations of this application, information sent by one terminal can be displayed in the window on the plane C. This can avoid a message corresponding to a terminal occupying an excessively large display area, and the user can select to display information corresponding to which terminal, thereby improving user interaction experience.

In a possible implementation, the electronic device may send a request message to a server, where the request message is used to request the server to send a verification message to a third terminal. Then, after receiving the verification message, the third terminal may forward the verification message to the electronic device, and the electronic device displays the verification message on the plane C of the electronic device. For example, when the user opens a platform on the plane B by using a web page, the user needs to send a verification message to a user terminal. After receiving a verification message sent by the platform, the terminal may forward the verification message to the electronic device, and the electronic device displays the verification message on the plane C. The user can observe the verification message on the plane C, without opening the terminal, to complete verification on the platform, thereby improving user experience.

In a possible implementation, if a fourth terminal is detected to be in a screen-off state, information sent by the fourth terminal is displayed on the second display, where the fourth terminal is any one of at least one terminal; or if information sent by a fourth terminal includes information generated by a first application, and the first application is an application included in the preset list, the information sent by the fourth terminal is displayed on the second display; or if a fourth terminal is detected to be in a screen-off state, and information sent by the fourth terminal includes information generated by a first application, the information sent by the fourth terminal is displayed on the second display.

Therefore, implementations of this application can be adapted to a plurality of terminal interaction scenarios. When a terminal screens off or runs a specific application, information in the terminal can be sent to the electronic device for display on the plane C, thereby improving user experience.

Optionally, the window displayed on the second display can be switched to the first display for display, thereby implementing display switching between the first display and the second display. For example, the second display data displayed on the second display is obtained. If a drag operation on the window corresponding to the second display data is detected, seventh display data is generated based on sixth display data, and the seventh display data is displayed on the first display. For example, the user may drag the window on the second display to the first display. When the window on the second display is switched to the first display for display, a size of the window and content included in the window may be adjusted, for example, the size of the window and a displayed data amount are increased, so that the window is more adaptive to the first display, thereby improving viewing experience of the user.

Optionally, historical data displayed on the first display within a preset time period may be obtained, prompt data is generated based on the historical data, and the prompt data is generated on the second display, to prompt an event generated in the historical data. For example, a conference record displayed in a display window on the first display may be obtained, and the conference record is displayed on the second display, so that a user can be reminded in time, thereby improving user experience.

Optionally, the second display may further include a keyboard window, configured to display a virtual keyboard. Therefore, the virtual keyboard can be displayed on the second display, so that the user can perform an input operation on the second display, thereby improving user experience.

Optionally, if an operation of expanding the second window is detected, the keyboard window may be closed, or a size of the keyboard window may be reduced, so that the expanded second window and another window do not overlap, thereby improving viewing experience of the user.

After the virtual keyboard is closed, a control corresponding to the virtual keyboard or a corresponding small icon may be displayed on the second display. When the user needs to reopen the virtual keyboard, the user may click the control or the icon to reopen the virtual keyboard, so that the user can use the virtual keyboard to perform input, thereby improving user experience.

The foregoing describes the procedure of the method provided in this application. For ease of understanding, the following describes in more detail an example with reference to a GUI provided in this application.

First, this application provides an electronic device. The electronic device includes a first display, a second display, a memory, and one or more processors, the memory stores code of a graphical user interface of an application, and the one or more processors are configured to execute the code of the graphical user interface (GUI) stored in the memory, to display the graphical user interface on the first display or the second display; and the graphical user interface includes:
determining second display data based on first display data in response to an operation on a display window on the first display, where the first display data is data displayed in the display window on the first display, the second display data includes data corresponding to a selected control in the first display data, and the second display data is less than the first display data; and displaying, on the second display, a window corresponding to the second display data.

In a possible implementation, the graphical user interface further includes: if the second display includes a plurality of display windows, in response to a slide operation on the plurality of display windows, selecting, on the second display based on the slide operation, a preset quantity of windows from the plurality of display windows for display, where the plurality of display windows do not overlap on the second display.

In a possible implementation, the operation on the display window corresponding to the first display data includes at least one of the following operations performed on the first display:
a drag operation, a close operation, a minimize operation, control selection, file selection, a play operation, a gesture operation, or a fold operation; and
the drag operation includes an operation of moving the display window after the display window is selected, the close operation is an operation of closing the display window, the minimize operation is an operation of hiding the display window, the control selection is an operation of selecting a control in the display window, the file selection is an operation of selecting a file displayed in the display window, the play operation is an operation of playing data displayed in the display window, the gesture operation is an operation formed by a gesture for controlling the display window, and the fold operation is adjusting an included angle between the first display and the second display.

In a possible implementation, if the operation on the display window corresponding to the first display data includes the drag operation, the determining second display data based on first display data includes: using at least one type of data in the first display data as the second display data; and the displaying, on the second display, a window corresponding to the second display data includes: determining a location, on the second display, of the display window of the second display data based on a location at which a cursor is released.

In a possible implementation, if the operation on the display window corresponding to the first display data includes the close operation or the minimize operation, the determining second display data based on first display data includes: scaling up or scaling down at least one type of data in the first display data, and/or deleting at least one type of data in the first display data, to obtain the second display data.

If the operation on the display window corresponding to the first display data includes the file selection, and a text in the display window is selected, the determining second display data based on first display data includes: using the selected text as the second display data; or translating the selected text, to obtain the second display data based on a translation result; or performing searching based on the selected text, to obtain the second display data based on a search result; or arranging the selected text, or obtaining an arrangement format corresponding to the selected text, to obtain the second display data; or if the selected text includes a value, performing exchange rate conversion on the value, to obtain the second display data.

If the operation on the display window corresponding to the first display data includes the file selection, and an image in the display window is selected, the determining second display data based on first display data includes: using the selected image as the second display data; or searching for a related image of the selected image, to obtain the second display data based on the related image; or performing target detection on the selected image, to obtain the second display data; or performing text recognition on the selected image, to obtain the second display data based on a recognized text.

If the operation on the display window corresponding to the first display data includes the play operation, the determining second display data based on first display data includes: obtaining, from the first display data, data related to a picture played on the first display, to obtain the second display data.

If the operation on the display window corresponding to the first display data includes the gesture operation, the determining second display data based on first display data includes: if detecting that the gesture corresponding to the gesture operation is a preset gesture, using at least one type of data in the first display data as the second display data.

In a possible implementation, if the operation on the display window corresponding to the first display data includes the fold operation, and the included angle between the first display and the second display is within a preset range, the determining second display data based on first display data includes: using the first display data as the second display data.

In a possible implementation, the displaying, on the second display, a window corresponding to the second display data includes: if detecting that a running application is an application in a preset list, or if detecting that the electronic device is in a preset mode, displaying, on the second display, the window corresponding to the second display data.

In a possible implementation, the GUI further includes:
in response to a click operation on a control in an interface of an application, obtaining fourth display data corresponding to the control clicked by the click operation, and replacing third display data displayed in an area corresponding to the first window with the fourth display data, where the first window is any window displayed on the second display.

In a possible implementation, a preset area on the second display includes at least one displayed preset window, and the at least one preset window displays at least one of a calendar, weather information, a trip record, a memo, or a note.

In a possible implementation, the GUI further includes: if detecting a drag operation on fifth display data displayed on the second display, using an area, corresponding to a location at which a cursor is released, on the second display as a display area of the fifth display data.

In a possible implementation, the GUI further includes: in response to obtaining information sent by at least one terminal, displaying, on the second display, the information sent by the at least one terminal.

In a possible implementation, the information sent by the at least one terminal includes data related to an application corresponding to the first display data.

In a possible implementation, the second display includes at least one window of a preset size that is arranged in a non-overlapping manner, and the GUI specifically includes: displaying, in the at least one window of the preset size that is arranged in the non-overlapping manner, the information sent by the at least one terminal.

In a possible implementation, the GUI specifically includes: obtaining information sent by a plurality of terminals, where the plurality of terminals include a first terminal and a second terminal; and displaying, in a second window on the second display, information sent by the first terminal; or
displaying, in the second window in response to a switch operation on the second window, information sent by the second terminal.

In a possible implementation, the obtaining information sent by at least one terminal includes: sending a request message to a server, to indicate the server to send a verification message to a third terminal, where the third terminal is any one of the at least one terminal; and receiving information sent by the third terminal, where the information sent by the third terminal includes the verification message.

In a possible implementation, the GUI includes:
if detecting that a fourth terminal is in a screen-off state, displaying, on the second display, information sent by the fourth terminal, where the fourth terminal is any one of the at least one terminal; or
if information sent by a fourth terminal includes information generated by a first application, and the first application is an application included in the preset list, displaying, on the second display, the information sent by the fourth terminal; or
if detecting that a fourth terminal is in a screen-off state, and information sent by the fourth terminal includes information generated by a first application, displaying, on the second display, the information sent by the fourth terminal.

In a possible implementation, the GUI further includes: obtaining sixth display data on the second display; and if detecting a drag operation on a window corresponding to the sixth display data, generating seventh display data based on the sixth display data, and displaying the seventh display data on the first display.

In a possible implementation, the GUI further includes: obtaining historical data displayed on the first display in a preset time period; generating prompt data based on the historical data; and displaying the prompt data on the second display, where the prompt data is used to prompt an event generated in the historical data.

In a possible implementation, the second display further includes a keyboard window, and the keyboard window displays a virtual keyboard.

In a possible implementation, the GUI further includes: in response to detecting an operation of expanding the second window, where the second window is any window displayed on the second display, closing the keyboard window, or reducing a size of the keyboard window, so that the expanded second window does not overlap the reduced keyboard window displayed on the second display.

Second, this application further provides an electronic device. The electronic device includes a first display, a memory, and one or more processors, the memory stores code of a graphical user interface of an application, and the one or more processors are configured to execute the code of the graphical user interface (GUI) stored in the memory, to display the graphical user interface on the first display or a second display; and the graphical user interface includes: sending a request message to a server, where the request message is used to request the server to send first information to a terminal; receiving second information sent by the terminal, where the second information includes the first information; and displaying the second information on the first display.

In a possible implementation, the displaying the second information on the first display includes:
if detecting that the terminal is in a screen-off state, displaying, on the first display, information sent by the fourth terminal, where the fourth terminal is any one of at least one terminal; or
if the second information includes information generated by a first application in the terminal, and the first application is an application included in a preset list, displaying the second information on the first display; or
if detecting that the terminal is in a screen-off state, and the second information includes information generated by a second application, displaying, on the first display, information sent by the terminal.

The following describes in more detail the procedure and an application scenario of the method provided in this application with reference to specific embodiments.

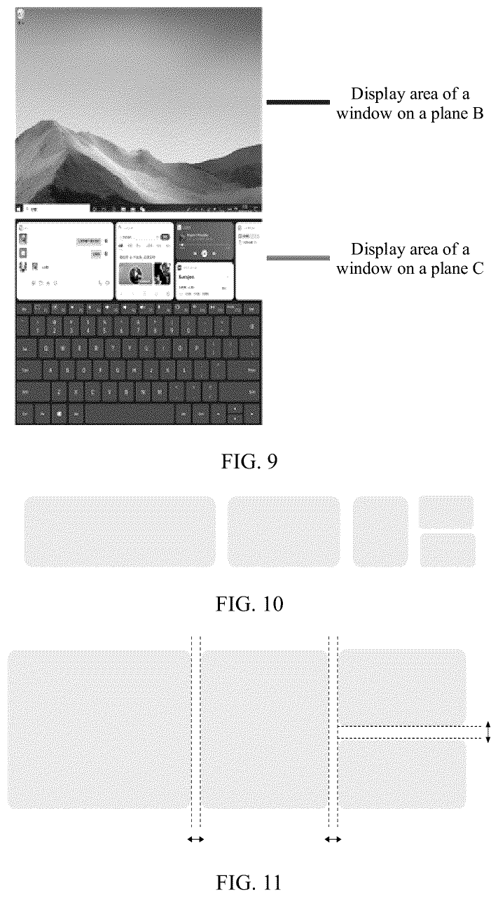

First, for example, a structure of an electronic device may be shown in FIG. 9, including a plane B (namely, a first display) and a plane C (including a second display). The plane B may display an application that the user selects to open or other data, and the plane C may display some card windows.

Optionally, the electronic device may further include a keyboard input area, and the keyboard input area may be a part of a display area on the plane C, namely, a virtual keyboard, or may be a physical keyboard. A user may perform input via the keyboard, for example, input a text via the keyboard. When the plane C further displays the virtual keyboard, the virtual keyboard may be adjusted or the virtual keyboard may be closed, for example, a size, a location, or a display manner of the virtual keyboard may be adjusted.

A size of the card window displayed on the plane C may be dynamically adjusted, or may be arranged based on a preset size. For example, as shown in FIG. 10, display windows of a plurality of sizes may be preset on the plane C, or the user may select the size and typesetting of the card window on the plane C. In addition, as shown in FIG. 11, a distance between the display windows may also be a preset distance, so that the windows displayed on the plane C can be independently displayed, and the windows are arranged appropriately, thereby improving viewing experience of the user.

Optionally, the display windows on the plane C (namely, the second display) may be classified into a plurality of types, for example, may be classified into a resident window and a dynamic window. The resident window is a window that is fixedly displayed on the plane C. Generally, the resident window is not closed when an application is closed. The dynamic window is a window that is not fixedly displayed on the plane C, for example, a window that is dragged from the plane B (namely, the first display) to the plane C, or a window that is displayed on the plane C after the plane B is closed. The following describes the method provided in this application by using an example with reference to different window types.

### 1. Resident Window

The resident window may be understood as a window that is continuously displayed on the plane C, for example, some reminder information, such as a schedule, a memo, weather information, a calendar, or a note that may be displayed on the plane C. Generally, the resident window is usually not closed as the application is closed, and may be continuously displayed on the plane C, so that some information that needs to be watched by the user in time can be presented on the plane C in time, thereby improving user experience.

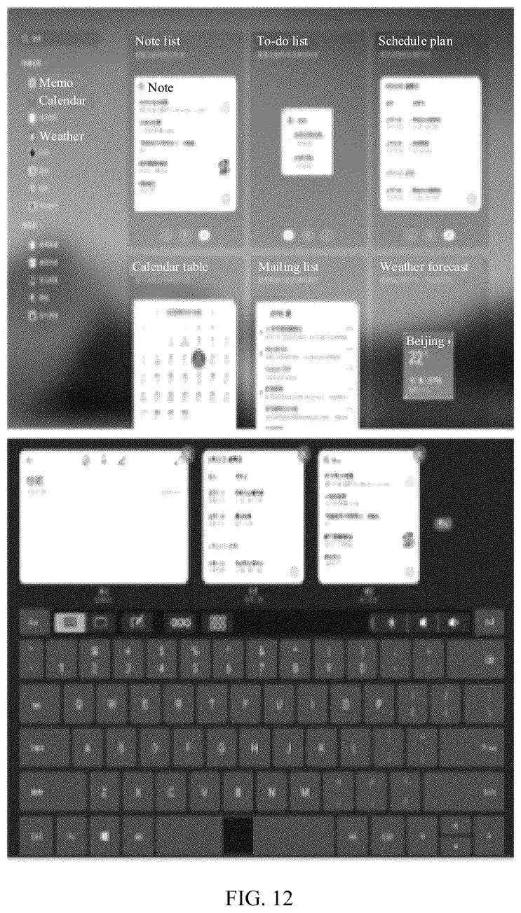

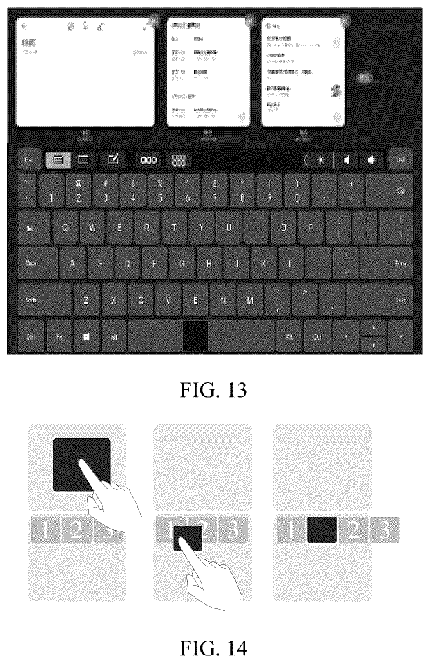

For example, as shown in FIG. 12, a resident window option may be added to a setting item of the electronic device, and the user may select the resident window from a display window on the plane B. As shown in FIG. 13, some frequently used cards may be displayed on the plane C, for example, the information such as the schedule, the note, the calendar, the weather, and the memo that the user needs to view in time, so that the user can view an important record in time, thereby improving user experience.

It may be understood that, on the second display provided in this application, the windows arranged in a card manner are used, so that the user can perform more convenient and effective interaction in the windows on the second display, and the arrangement manner can enable the user to interact with the electronic device more clearly, thereby improving viewing experience and interaction experience of the user.

### 2. Dynamic Window

The dynamic window may include a window that is displayed on the plane B, and then displayed on the plane C after being operated.

There are a plurality of manners for generating the dynamic window on the plane C. For example, an operation may be performed on data displayed on the plane B, and then data displayed on the plane C is generated based on the data displayed on the plane B and is displayed in the window on the plane C. The operation may specifically include selecting a control in the display window on the plane B, for example, a close control, a minimize control, a play control, a file icon control, or another preset control, and may further include operations such as dragging the window on the plane B and folding the electronic device.

The following uses some scenarios as examples to describe an example of a process of generating the dynamic window.

### 1. Drag Operation

The drag operation may be implemented by the user via a device connected to the plane B, like a mouse, a keyboard, or another control device. Alternatively, if the plane B is a touchscreen, the drag operation may be an operation of dragging the window on the plane B by the user by touching the plane B. After the drag operation is detected, the dragged window may be directly displayed on the plane C, or the window may be displayed after being adjusted. For example, a size of a display window on the plane C is usually less than a size of a display window on the plane B, and the dragged window may be reduced, for example, a part of content in the window is captured, or a part of important content is highlighted, so that the window displayed on the plane C is easier to perform interaction, thereby improving user experience.

For example, as shown in FIG. 14, the window displayed on the plane B may be dragged to the plane C by touching or via an input device, and a location at which a cursor is released is used as a display area of the window on the plane C. For example, the window on the plane B is dragged between a window 1 and a window 2 displayed on the plane C, and locations of windows on the plane C are adjusted, and the size of the dragged window may be adjusted, so as to insert the window between the window 1 and the window 2. If a window 3 is squeezed out of the display area on the plane C, the window 3 may be hidden. When the user slides on the plane C, the window 3 may be displayed based on a slide operation of the user.

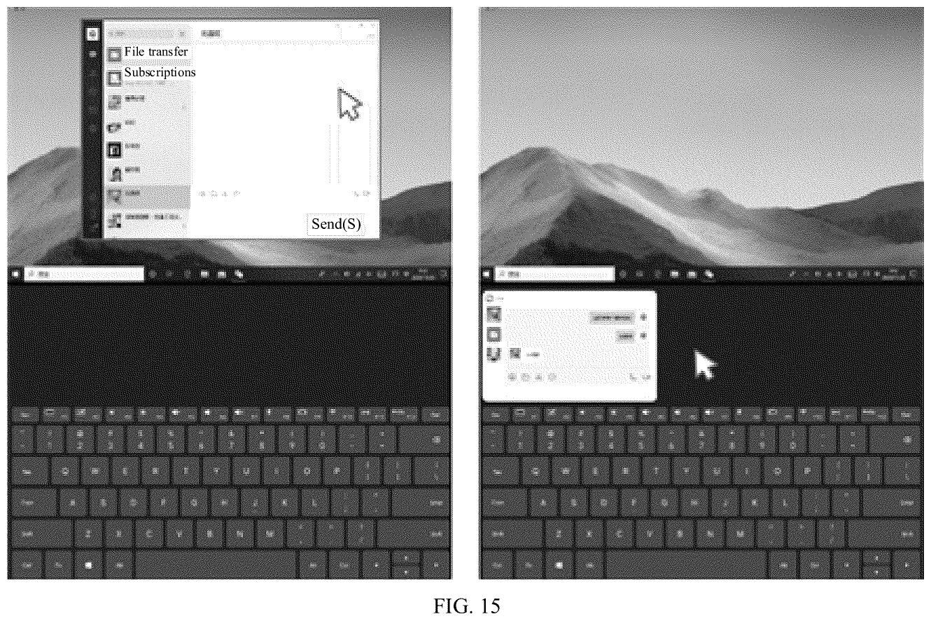

More specifically, for example, as shown in FIG. 15, the user may drag, by using a mouse cursor, a window displayed on a primary display (namely, the plane B) to a secondary display (namely, the plane C), and this type of window is closed as an application corresponding to the window ends, or is actively closed due to an operation of the user. Drag manners include mouse and gesture manners. The following procedure uses mouse cursor dragging as an example. The user can select a current window by touching and holding via a cursor and drag the current window by controlling a moving direction of the mouse. When the drag operation of the user is detected, if it is detected that a window movement location overlaps a lower boundary of the plane B, or the mouse or a finger touches a boundary, or the windows is dragged to the plane C, the window may be displayed on the plane C. When the window is displayed on the plane C, the window on the plane C is usually smaller than the window on the plane B. To facilitate user interaction, the window displayed on the plane C may be adjusted. As shown in FIG. 15, a part of content currently selected by the user may be enlarged, and a part of content that is not selected may be hidden, so that the user can perform interaction more conveniently, thereby improving user experience.

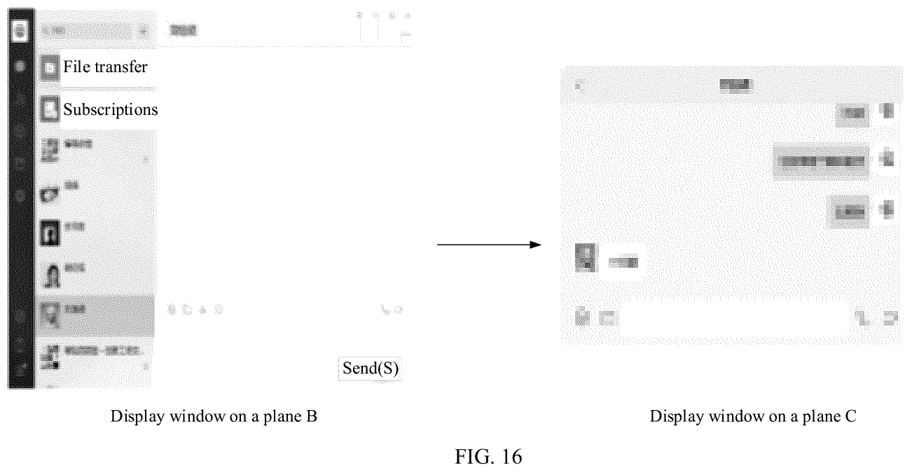

A chat software is used as an example. Generally, when a window display area is limited due to display of a soft keyboard on the plane C, or a display area on the plane C is small, and the window on the plane B is usually displayed large, if the window is directly moved to the plane C for display, a text and an interaction control are displayed very small, and it is difficult to click and interact with a finger. In addition, a function is excessively complex for touchscreen interaction, and user experience is poor. The problem can be resolved in a simplified mode in this application. Adaptation can be performed on the card window on the plane C, for example, an information architecture, an interaction control, a text size, and an interaction manner of a current window page are optimized, so that the card window is more appropriate for finger touchscreen interaction. As shown in FIG. 16, the window of the chat software displayed on the plane B is more comprehensive, and more contacts are displayed. When the window is switched to the plane C, a chatter list and a navigation bar are hidden. The user can easily view a newly received message without being interfered by other redundant information or causing accidental touch due to other interaction controls.

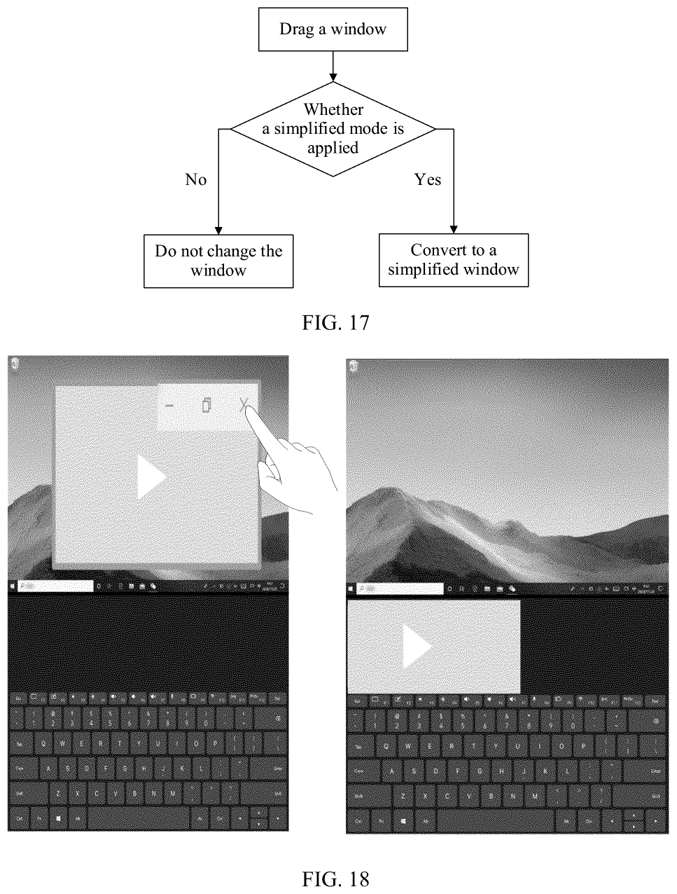

When the user performs the drag operation, a procedure of the drag operation may be shown in FIG. 17. When it is detected that the user drags the window, whether the simplified mode is applied is determined. If the simplified mode is not applied, the window is not changed; or if the simplified mode is applied, the window is converted to a simplified window.

The user may drag the window in an input manner by using a mouse or through touching.

A manner of determining whether the simplified mode is applied may be determining whether the window meets a preset application condition, for example, whether the size of the window is greater than a first preset size, whether the display area on the plane Cis greater than a second preset size, or whether an application corresponding to the window is in a preset list.

When the application condition is met, for example, the window is excessively large or the display window on the plane C is excessively small, the window may be adjusted, and the window is converted into the simplified window, for example, a navigation bar in the window is removed, or a currently selected part of content is reserved, so that more practical content can be displayed on the plane C, thereby improving user experience.

When the application condition is not met, for example, the size of the window is not large, or the display area on the plane Cis large enough, the window may not need to be adjusted, and more content is reserved in the window, thereby improving user experience.

Therefore, in implementations of this application, the size of the window displayed on the plane C can be determined based on the window or the display area on the plane C, so that the window displayed on the plane C is more adaptive to the display area on plane C, thereby improving user experience.

### 2. Close Operation or Minimize Operation

The user may implement the close operation in a plurality of manners. For example, the user selects to close the display window in a taskbar displayed on the first display, or selects a close control in the display window to implement the close operation or the minimize operation, or implements the close operation or the minimize operation via an input device like a keyboard or a gesture operation.

In addition, the user may preset a program list that needs to be displayed on the plane C after the close operation or the minimize operation is performed. When the user performs the close operation or a minimize operation on a window, if a program corresponding to the window is in the list, the corresponding window may be generated on the plane C. Therefore, after the window on the plane B is closed or hidden, the window may continue to be displayed on the plane C based on a user requirement, thereby improving user experience.

For example, as shown in FIG. 18, the user may select a close control in a display window on the plane B via an input device like a mouse, a keyboard, or a touchscreen, to close the window on the plane B. A background of the electronic device may continue to run an application corresponding to the window, or may close an application corresponding to the window. After the user selects to close the window, the closed window or content related to the window may be displayed on the plane C. For example, the window selected by the user to close may be reduced for display, or an icon related to the closed window may be displayed on the plane C.

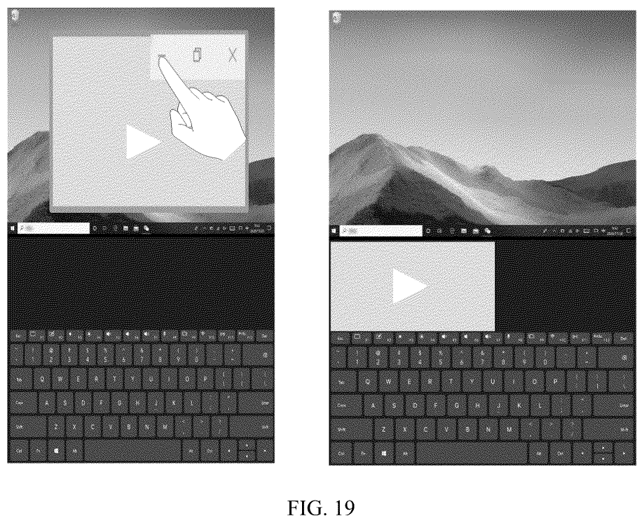

For example, as shown in FIG. 19, the user may select, via an input device like a mouse, a keyboard, or a touchscreen, a minimized control in the display window on the plane B, to hide the window on the plane B. A background of the electronic device may continue to run an application corresponding to the window, and display a small window of the application on the plane C.

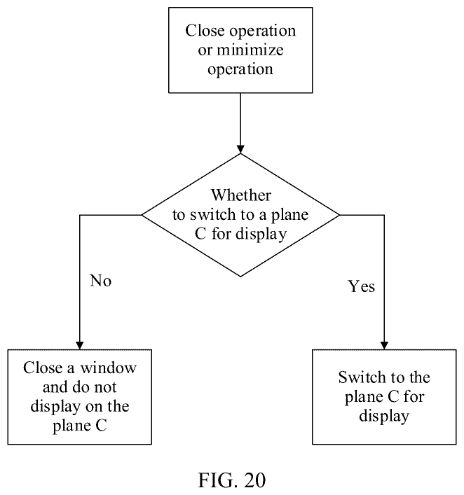

For example, a procedure in which the user starts the close operation or the minimize operation may be shown in FIG. 20.

The user may perform the close operation or the minimize operation in an input manner by using the mouse or through touching.

When the close operation or the minimize operation is detected, whether the window operated by the user needs to be switched to the plane C for display is determined; and if the window operated by the user does not need to be switched to the plane C for display, the window is closed and is not displayed; or if the window operated by the user needs to be switched to the plane C for display, the window is switched to the plane C for display.

There may be a plurality of manners of determining whether to switch the window to the plane C for display, for example, determining whether a program corresponding to the window operated by the user is in a preset program list, or whether a size of the window exceeds a preset size.

When it is determined that the window operated by the user does not need to be switched to the plane C for display, the window may be closed, the program corresponding to the window is run in the background, the program is closed, or the like.

When it is determined that the window operated by the user needs to be switched to the plane C for display, the window may be moved to the plane C, or the window is adjusted to a simplified window and then switched to the plane C for display, or the like.

### 3. File Selection

Various file icons may be displayed in the window on the plane B. Each icon may be linked to a file stored in the electronic device. When selecting one of the files, the user may read a file from storage space and perform a subsequent operation, like displaying, copying, or cutting.

Optionally, when the selected file includes a text, data displayed on the plane C may be obtained based on the selected text. For example, the selected text may be directly used as the data displayed on the plane C; or the selected text may be translated, and a translation result is displayed on the plane C; or searching may be performed on the selected text, and a search result is displayed on the plane C; or after the selected text is determined, an arrangement format or a typesetting format corresponding to the text may be searched for, and a search result is displayed on the plane C; or if the selected text includes a value, calculation may be performed on the value, for example, exchange rate conversion or other mathematical calculation, and a calculation result is displayed on the plane C.

Optionally, when the selected file includes an image, data displayed on the plane C may be obtained based on the selected image. For example, the selected image may be directly displayed on the plane C; or a related image of the selected image may be searched for, and the related image obtained by searching is displayed on the plane C; or target detection is performed on the selected image, and a detection result is displayed on the plane C; or text recognition is performed on the selected image, and display content on the plane C is obtained based on a recognition result. For a display manner after a text is obtained by performing text recognition on the selected text, refer to the foregoing display manner when the selected file includes the text. Details are not described herein again.

For ease of understanding, the following uses an example to describe a case in which the file is selected.

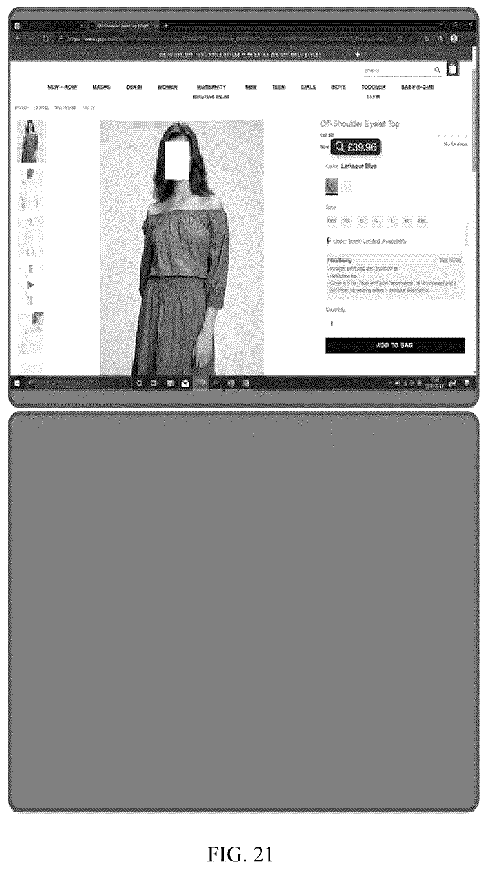

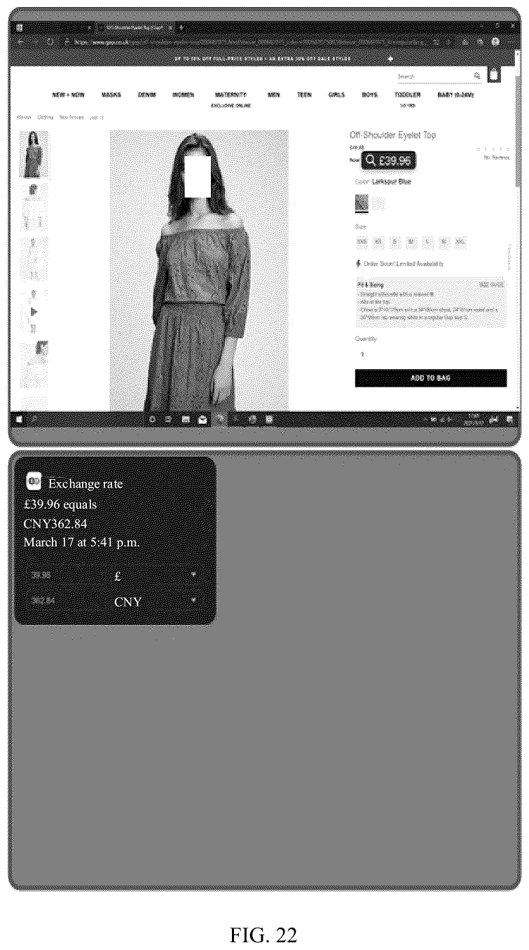

First, the window displayed on the plane B of the electronic device may be shown in FIG. 21, where an image and a plurality of types of texts are displayed.

For example, a value may be selected. If a currency symbol is carried before the value, exchange rate conversion may be performed on the value, as shown in FIG. 22. Then, a card is generated, and a result obtained after exchange rate conversion is displayed on the plane C. For example, when a currency type displayed in the display window is a currency type that is not commonly used by the user, the value may be selected by pressing or sliding, and the user may select a currency type obtained after conversion, so that the selected value can be converted into the currency type required by the user, thereby improving user experience.

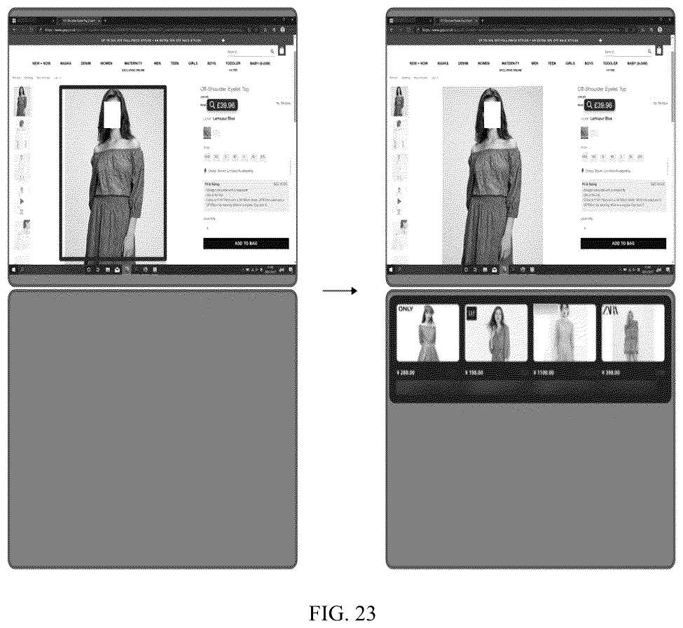

For another example, as shown in FIG. 23, after selecting the image in the display window, the user may search for the displayed image to obtain a plurality of frames of related images, and display, on the plane C, the plurality of frames of related images obtained through searching. For example, when the user subscribes to an offering, if the user opens an offering link and selects a frame of image, the user can perform searching on the image, and obtains, through searching, similar offering images based on the image and display the images on the plane C. The user can select an offering displayed on the plane C and open a selected offering link to quickly find a required offering, thereby improving user experience.

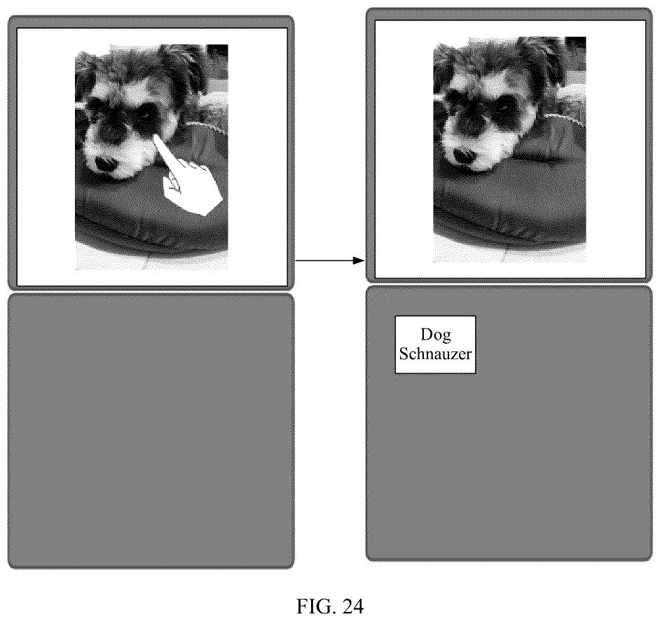

For another example, as shown in FIG. 24, the user may browse an image on a plane B. When the user is interested in a frame of image, the user may select the image in an input manner like touching or a mouse. After the operation of selecting the image by the user is detected, the image may be recognized. As shown in FIG. 24, a target included in the image is recognized as a “dog”, and a specific type is “Schnauzer”, and a recognition result may be displayed in the window on the plane C. This implements quick response to an image selected by the user, thereby improving user experience.

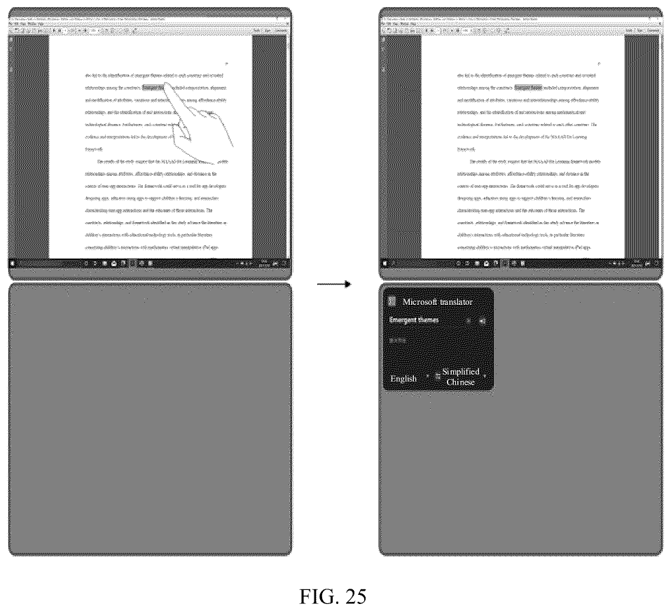

The text may be directly selected in the display window on the plane B, or the text may be recognized from the selected image. For example, as shown in FIG. 25, a document may be displayed on the plane B, and the user may select a section of text in the document by touching or selecting via a mouse. After the text selection operation of the user is detected, the selected text may be translated to obtain a translated text, and the translated text is displayed on the plane C. A specific translation language may be selected by the user, or may be a preset common translation language. After it is detected that the user selects the text, translation may be performed, or after the user triggers a translation operation, translation may be performed on the selected text.

For example, a text may be displayed on the plane B, and the user may select a section of text in the text by touching or selecting via a mouse. After the text selection operation of the user is detected, the text selected by the user may be searched for, and a search result is displayed on the plane C, so that the text selected by the user can be searched for in time, without changing content displayed on the plane B, thereby improving user experience.

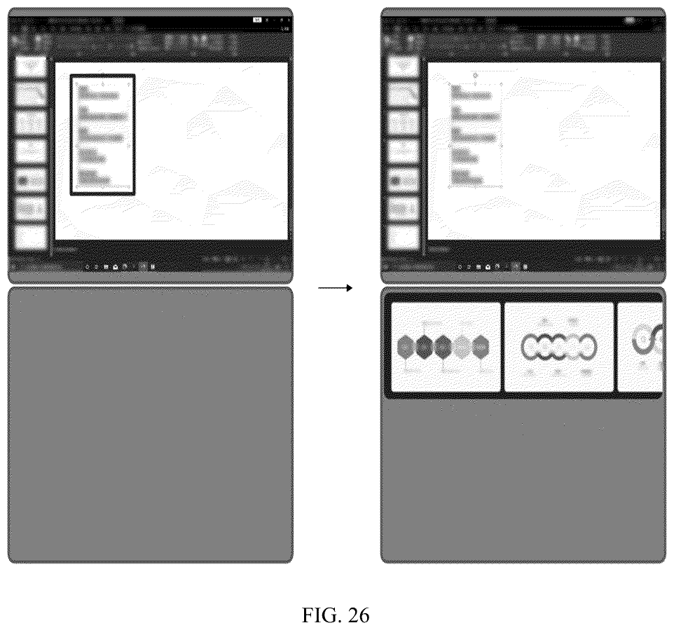

For another example, as shown in FIG. 26, a text may be displayed on the plane B, and the user may select a section of text in the text by touching or selecting via a mouse. After the text selection operation of the user is detected, a typesetting format corresponding to the text may be searched for and displayed on the plane C. The user may select a required typesetting format on the plane C, and typeset the text selected on the plane B in the typesetting format selected by the user. Therefore, in a scenario in which the user needs to typeset a text, a required typesetting format can be quickly obtained through searching, thereby improving user experience.

### 4. Play Operation

The user may choose to perform the play operation on a plurality of types of data in the electronic device, for example, a video, audio, or a slide. During playing, data related to a current playing image can be obtained and a corresponding window can be displayed on the plane C. For example, searching may be performed on a played image, and a search result is displayed on the plane C; or when a slide is played, comment information corresponding to a currently played image may be displayed on the plane C. Therefore, when playing the video, the audio, or the slide in full screen on the plane B, the user can also learn of related information on the plane C, thereby improving user experience.

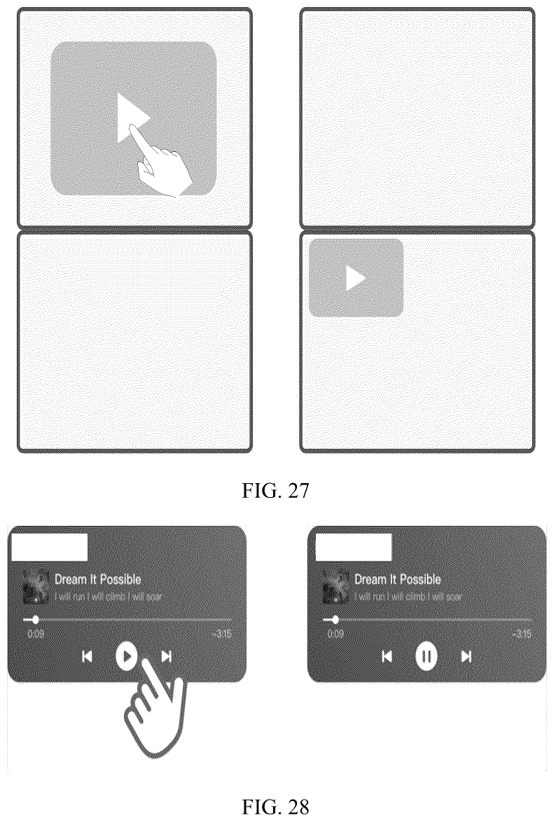

For example, as shown in FIG. 27, when the user plays the video, if the user needs to hide a video window on the plane B, the user may choose to play the video on the plane C, so that the user can display another window on the plane B when watching the video, thereby improving user experience. Alternatively, as shown in FIG. 28, when the user plays music, the user may select a minimize operation, that is, hide a music window played on the plane B. In this case, the user may continue to play the music on the plane C, and the user may select a fast-forward, rewind, or pause operation in a playing window on the plane C.

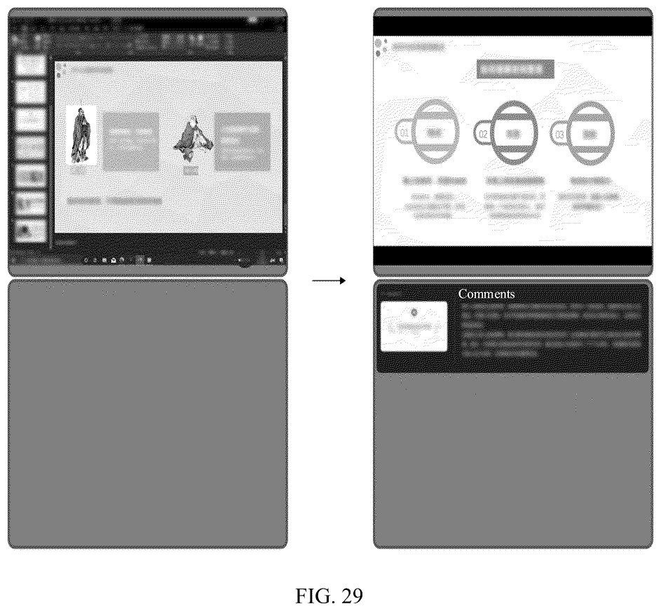

For another example, as shown in FIG. 29, when the user selects to play slides by clicking or touching, the user adds comment information to a slide, and when the slide is played, the plane B does not display the comment information, and the comment information may be displayed on plane C. Therefore, even when the user plays the slide in full screen on the plane B, the comment information can still be observed on the plane C, thereby improving user experience.

### 5. Gesture Operation

A gesture of the user may be collected in a plurality of manners, for example, the gesture operation of the user is collected via a radar, a camera, or an infrared ray. When it is detected that the gesture of the user is a preset gesture, data displayed on the plane C may be generated based on data displayed on the plane B, and the data is displayed on the plane C.

Specifically, a plurality of gestures may be preset, for example, a window drag gesture, a window close gesture, a window minimize gesture, a play gesture, or a file selection gesture, so that the user can perform control by using a gesture, without touching the electronic device, thereby improving user experience. For a manner of generating the display data on the plane C, refer to the foregoing generation manners corresponding to the drag operation, the close operation, the minimize operation, the file selection operation, or the play operation. Details are not described herein again.

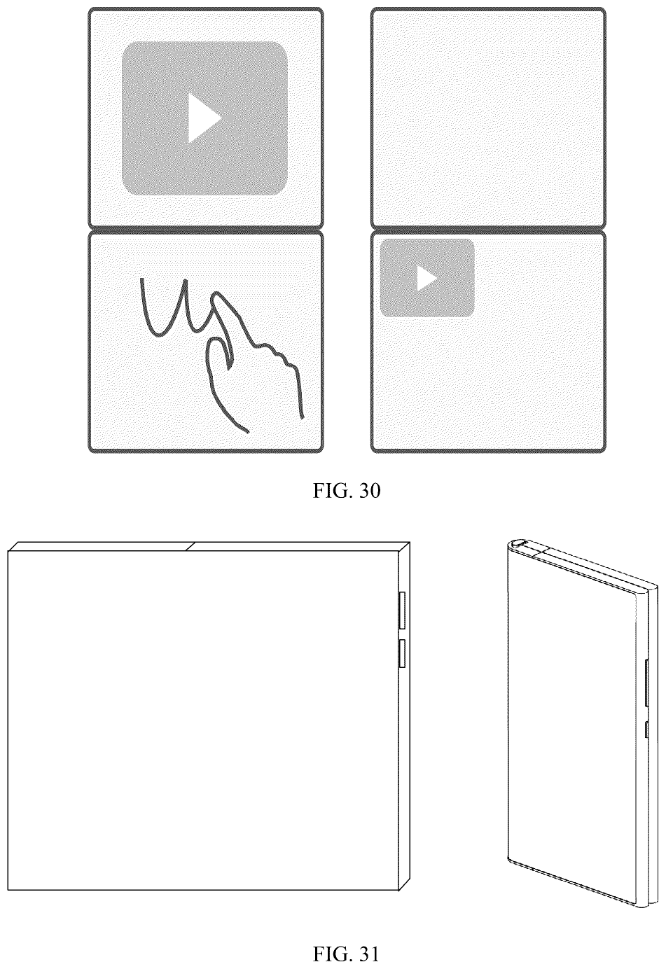

For example, as shown in FIG. 30, when a frame of image is displayed on the plane B, the user may perform the gesture operation. After the gesture of the user is collected and recognized, whether the gesture is the preset gesture is determined. If the gesture is the preset gesture, for example, the window drag gesture, the gesture may be responded to, and the data displayed on the plane B is transferred to the plane C for display.

Therefore, in implementations of this application, the user can switch, by using the gesture operation, the window displayed on the plane B to the plane C for display, thereby improving control experience of the user.

### 6. Fold Operation

The electronic device provided in this application may have a plurality of displays. For example, an electronic device has two displays. The two displays may not be fixedly connected. Therefore, the fold operation may be performed on the electronic device. When the fold operation of the user is detected, data displayed on the plane C may be generated based on data displayed on the plane B, or data displayed on the plane B is used as data displayed on the plane C, or the like.

For example, the electronic device may be a foldable tablet. When the user needs to fold the tablet, the two displays may be folded at any angle. As shown in FIG. 31, when the user folds the tablet, the plane C faces the user. In this case, the plane C may be used as a primary display for display. In this case, content displayed on the plane B may be switched to the plane C for display. Therefore, even if the electronic device is in a different form, the electronic device may respond to form switching in time, so that the user can view the content displayed on the primary display, thereby improving user experience.

Specifically, for example, some common devices support only two window management modes, such as a keyboard and mouse window system and a tablet window system. To improve user experience, this application provides a card window. As a form and a use scenario of a multi-screen device change, a window system also needs to change accordingly. A sensor in the device may sense a status of the device, to infer a use scenario in this case, and recommend a most appropriate window system. The sensor may include but is not limited to an angle sensor, an IMU sensor, a magnetic sensor, and the like.

For example, a relationship between a form of the device and a display manner of the plane B or the plane C may be shown in Table 1.

TABLE 1

| Form of the device | Plane B | Plane C |
|---|---|---|
| L-shaped, with a soft/hard keyboard | Keyboard and | Card window |
| | mouse window | |
| L-shaped, without a soft/hard keyboard | Keyboard and | Tablet window |
| | mouse window | |
| Expanded at 180° and horizontally | Tablet window | Card window |
| placed, with a soft/hard keyboard | | |
| Expanded at 180° and horizontally | Tablet window | Tablet window |
| placed, without a soft/hard keyboard | | |
| Expanded at 180° and vertically | Keyboard and | Card window |
| placed, with a soft keyboard | mouse window | |
| Expanded at 180° and vertically | Keyboard and | Keyboard and |
| placed, with a hard keyboard | mouse window | mouse window |
| (contactless connection) | | |
| Tent form, with a soft/hard keyboard | Tablet window | Card window |
| Tent form, without a soft/hard keyboard | Tablet window | Tablet window |

When the device is placed on a desktop in an L-shaped manner (for example, in an open form of a notebook), and the soft keyboard is displayed on the plane C, the plane B may be set to a keyboard and mouse window mode, and the plane C may be set to a card window mode, that is, the plane B displays the keyboard, and the plane C displays the card window. However, when the user collapses the soft keyboard, the mode determines that the user wants to use the application window in full screen on the plane C, and the plane C may be set to a tablet window mode.

When the user expands the device at 180°, horizontally places the device on a desktop, and does not display the additional soft keyboard, it may be understood that the user wants to use the device as a whole tablet, for example, in a use scenario like a drawing or a two-player game. Both the plane B and the plane C may be set to the tablet window mode.

When the user expands the device at 180°, vertically places the device on a bracket, and does not display the additional soft keyboard, it may be understood that the user may use an external connected physical keyboard and an external connected mouse as inputs, and use the device as a whole display. The mode sets both the plane B and the plane C to the keyboard and mouse window mode.

However, when the user continues to fold the device, stands the device in the tent form on the desktop, and does not display the additional soft keyboard, it may be understood that the user may want to present the device to a person on an opposite side, and therefore, both the plane B and the plane C are set to the tablet window mode.

### 7. Terminal Interaction

The terminal may include a terminal like a band, a mobile phone, a tablet, or a smart screen. The terminal may establish a wired or wireless connection to the electronic device, and communicate with the electronic device through the wired or wireless connection.

The electronic device may receive information sent by the terminal, and the information may include a display interface of the terminal, information received by the terminal, notification information sent by the terminal to the electronic device, or the like. A window of the information sent by the terminal may be generated on the plane C.

For example, an application list may be preset and includes information about one or more applications installed on the terminal. When starting an application in the application list, the terminal may send related information about the application to the electronic device, so as to display the received information on the plane C.

Specifically, there may be a plurality of scenarios for interacting with the terminal. For example, an interface of the terminal is transmitted to the electronic device, so that the user can control the terminal by using the electronic device, or the terminal sends a plurality of reminder messages to the electronic device. The following describes some possible scenarios by using examples.

### Scenario 1: A Terminal Shares an Interface.

The terminal may transmit information about all or a part of the display interface of the terminal to the electronic device for displaying the display interface of the terminal on the plane B or the plane C in real time, so that the user can control the terminal on the plane B or the plane C, without operating the terminal, thereby improving user experience.

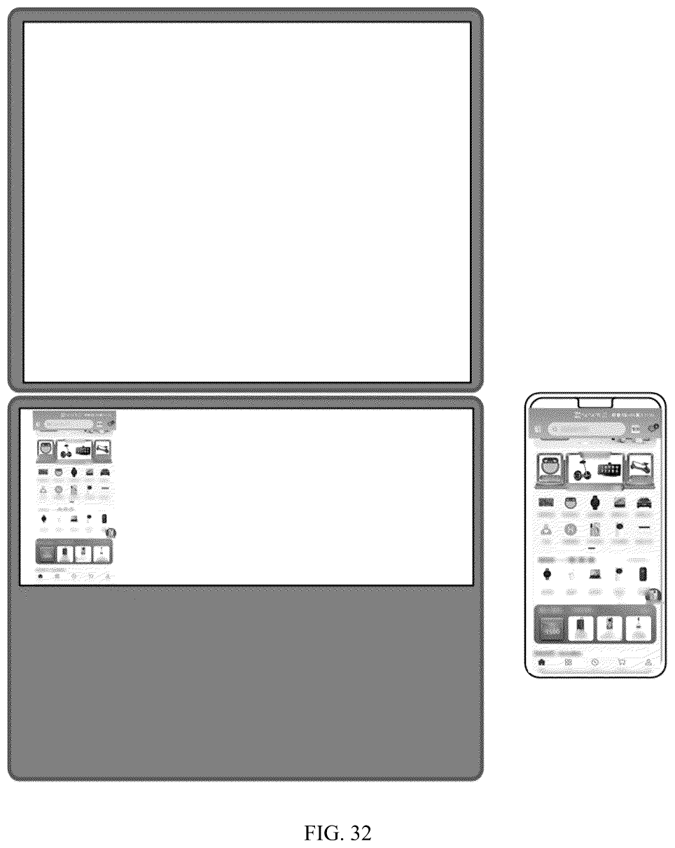

For example, as shown in FIG. 32, the current interface of the terminal may be transmitted to the electronic device, and displayed on the plane C. The user may perform an operation in a display window on the plane C, and the electronic device may transmit an operation instruction to the terminal, so that the terminal performs corresponding feedback. As shown in FIG. 33, the user may open a piece of chat software of the terminal on the plane C, and perform input and send a message in the interface. Therefore, the user only needs to operate the electronic device to control the terminal, without operating the terminal, that is, the user can control a plurality of devices by using the electronic device, without opening the plurality of devices, thereby improving user experience.

In addition, in some scenarios, for example, when the terminal screens off, an interface of a running application before the terminal screens off may be projected to the electronic device; or an application list may be preset, and if a running application before the terminal screens off is an application in the application list, an interface of the running application before the terminal screens off may be projected to the electronic device.

In some scenarios, an interface of an application running on the terminal may be projected to the electronic device by using a preset operation. For example, when the terminal touches the electronic device, the interface of the application running on the terminal may be projected to the plane B or the plane C of the electronic device.

### Scenario 2: A Terminal Sends a Message to the Electronic Device

The terminal may send a plurality of messages to the electronic device, for example, a message received by the terminal or a reminder message generated by the terminal.

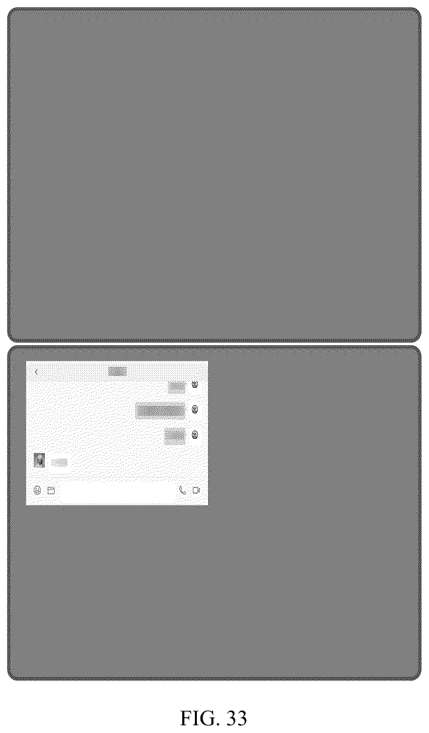

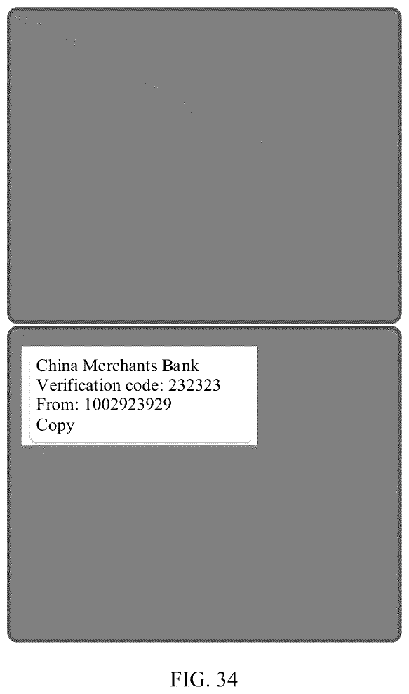

For example, the terminal may send a received message to the electronic device. For example, when a user is registering a new account on an application on a plane B of the device, the registration requires login using a mobile phone verification code, but SMS message information can be received only by a mobile phone, and the verification code needs to be input into the device. Alternatively, a user may open a web page on the plane B of the electronic device, when the user logs in to a website, an application server corresponding to the website usually sends a verification message to a mobile phone of the user to verify an identity of the login user. When receiving the verification message sent by the application server, the terminal may send the verification message to the electronic device, and the electronic device may display the verification message on the plane C, as shown in FIG. 34, so that the user can obtain, through observing, the verification code on the plane C, without opening the mobile phone, thereby improving user experience.

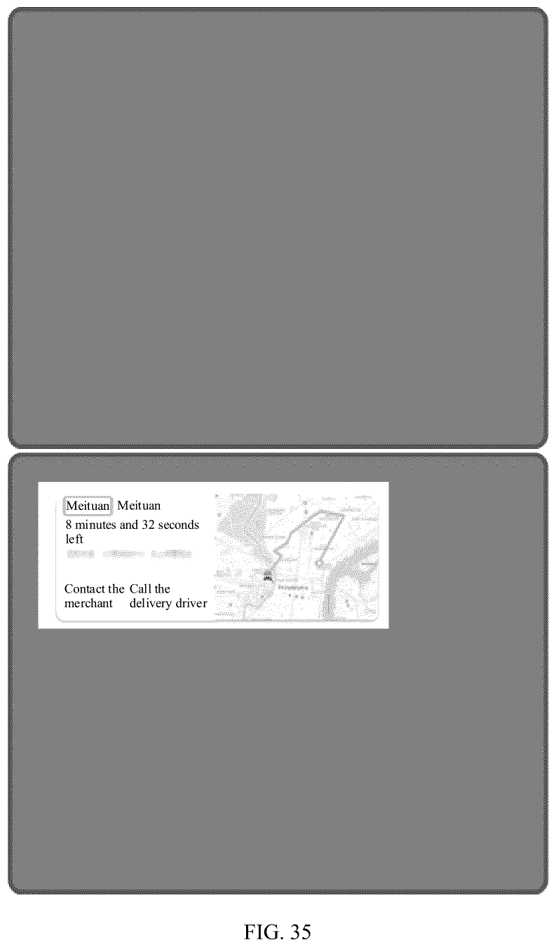

For another example, for a message generated by the terminal, for example, after a user orders a meal on a takeout platform on a mobile phone, the user continues to use the electronic device to process work, and the mobile phone is placed aside and is not used. In this case, to avoid missing a takeout message, the mobile phone may send, to the electronic device, information generated by takeout software, so as to display a takeout progress, a delivery notification, or the like on a plane B or a plane C of the electronic device. As shown in FIG. 35, predicted delivery time of the takeout, a contact of a merchant or a takeout person, and the like may be displayed on the plane B or the plane C.

### Scenario 3: Switch Terminal Information.

An electronic device may establish connections to a plurality of terminals. When receiving information sent by the plurality of terminals, the electronic device may fold the information from the plurality of terminals. A user may manually switch a card, or when a terminal sends a message, a user switches a card window to a message received in real time.

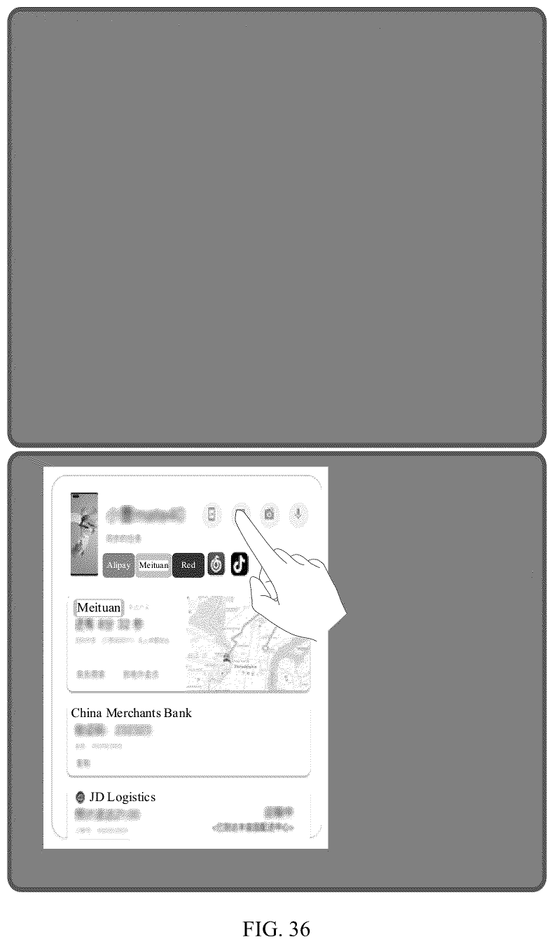

For example, as shown in FIG. 36, when the electronic device is connected to the plurality of terminals, one or more messages from one of the terminals may be displayed in the card window. When the user needs to switch to view information from another terminal, the user may select a switch control, to switch the window to display the information from the another terminal.

Specifically, displaying information exchanged between the electronic device and the terminal on the plane B or the plane C may be determined based on a current running status of the electronic device. For example, when the electronic device is in a preset state, the information exchanged with the terminal may be displayed on the plane C. For example, when the electronic device is currently playing a video in full screen, using learning software, or is set to be in a do-not-disturb state, when receiving the information from the terminal, the electronic device may display the received information on the plane C.

In addition, the user may alternatively choose to display the received information on the plane B or the plane C. For example, the user may preset a display location of information from a terminal.

The foregoing describes content displayed on the plane C of the electronic device. In addition, a window displayed on the plane C includes the foregoing resident window and the foregoing dynamic window, and may be adjusted, for example, a size, a location, and a display manner of the window may be adjusted, or the window may be adjusted to be displayed on the plane B.

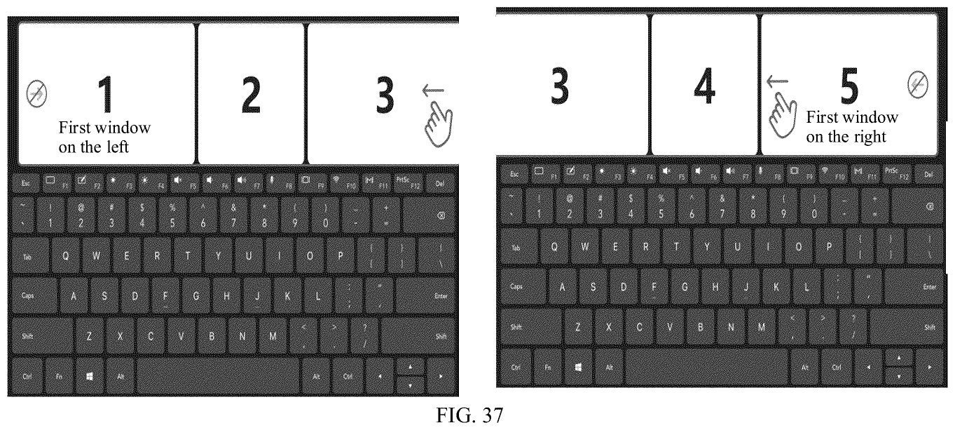

In some scenarios, if a quantity of windows displayed on the plane C exceeds a quantity of windows that can be displayed, some windows may be displayed on the plane C, and some windows may be hidden. When the user needs to view the hidden windows, the user may slide to display the windows on the plane C by using a window slide window. For example, as shown in FIG. 37, the user may slide left or right to view hidden windows on left and right sides. For example, the user slides left. There is no hidden window on the left side, and therefore when the user slides right, there is no hidden window displayed. The user may slide left to view the hidden window on the left side. After sliding to a leftmost window 5, that is, a last window, and when the user slides left, there is no hidden window displayed, and a window 1 and a window 2 are hidden. The user may slide right to continue to display the window 1 and the window 2.

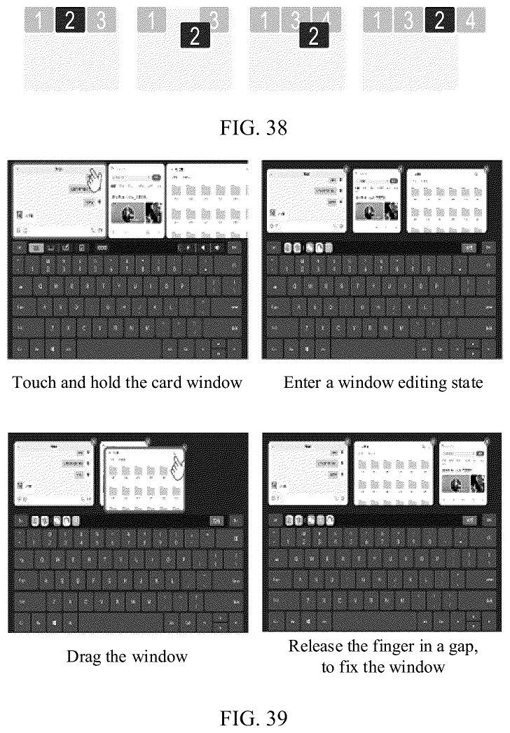

In some scenarios, the user can drag a window to adjust a location of the window. For example, as shown in FIG. 38, the user may adjust a location of each window. For example, the user may drag a window 2 on the plane C, and use a location at which a cursor is released as a display location of the window 2. The window 2 is located between a window 1 and a window 3 before adjustment, and the window 2 is located between a window 3 and a window 4 after the adjustment.

Specifically, for example, as shown in FIG. 39, the user may touch and hold a card window (namely, a window), to enter a window editing state, then drag the window, and release a finger in a gap, to fix the window.

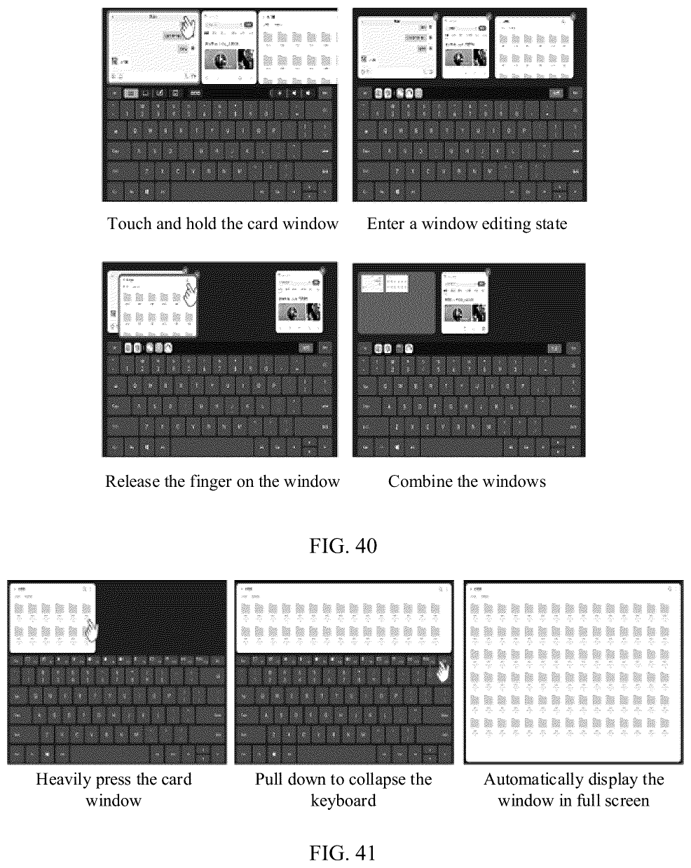

In some scenarios, the user can drag windows to combine the windows. For example, as shown in FIG. 40, the user may touch and hold a card window, to enter a window editing state. The user may select a window, and then drag the window to another window, to combine the two windows.

In some scenarios, the user can select a window to adjust a size of the window. For example, the user can adjust the size of the window by pinching out with two fingers or by selecting a control on the window. If the size of the window after expansion exceeds a display area on the plane C, and the plane C further displays a virtual keyboard, a size of the virtual keyboard may be adjusted, or the virtual keyboard may be closed, so that a display area of the window can be expanded, thereby improving user experience.

For example, the user may further directly change a size of a card window by using a gesture, and the gesture may be combined with pressure information. For example, the user may re-press a window to maximize a half screen of the window in the display area on the side C. If the device is a dual-screen or foldable screen and a common area on the plane Cis a soft keyboard, the size of the window may also be related to a display area of the soft keyboard on plane C. When the user collapses the soft keyboard, the window is automatically enlarged and displayed in full screen on the plane C. As shown in FIG. 41, a card window may be heavily pressed, and then a virtual keyboard may be collapsed by pulling down the window, so that the window can be displayed in full screen, that is, the window is displayed in full screen on the plane C.

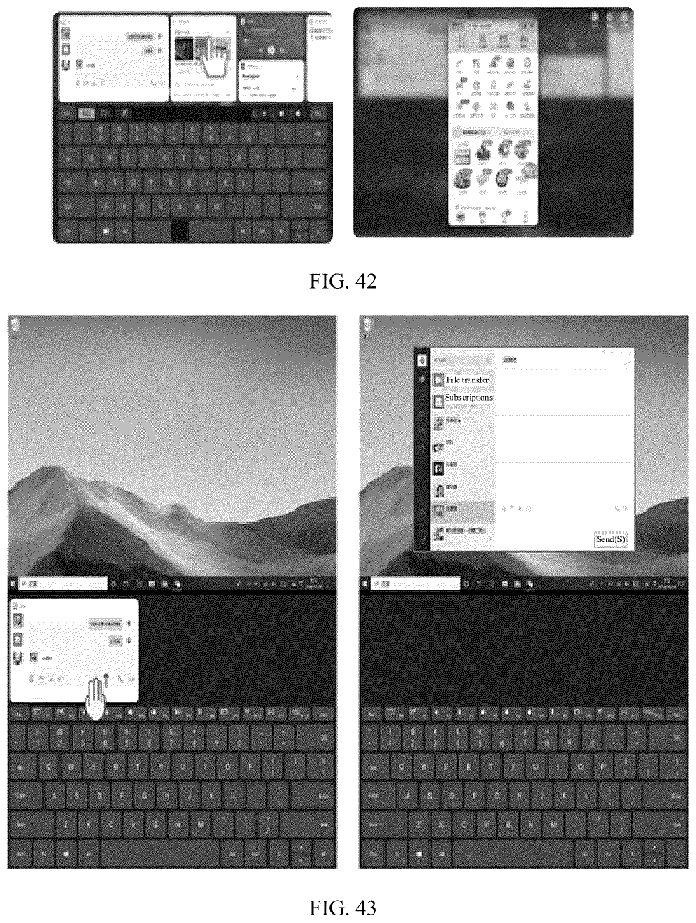

For another example, as shown in FIG. 42, a window on the plane C may be heavily pressed. In this case, a virtual keyboard may be collapsed, so that the window can be displayed in full screen, that is, the window is displayed in full screen on the plane C.

In addition, the window on the plane C may also be displayed on the plane B. Specifically, the window on the plane C may be switched to the plane B by using a mouse click operation or a touch operation. For example, as shown in FIG. 43, the user may perform a three-finger slide-up operation on the window displayed on the plane C, to switch the window displayed on the plane C to the plane B for display. Generally, the window displayed on the plane C is a simplified window, and some controls are scaled down or some controls are deleted. When the window on the plane Cis switched to the plane B for display, the window may be restored, and the window including more controls is displayed.

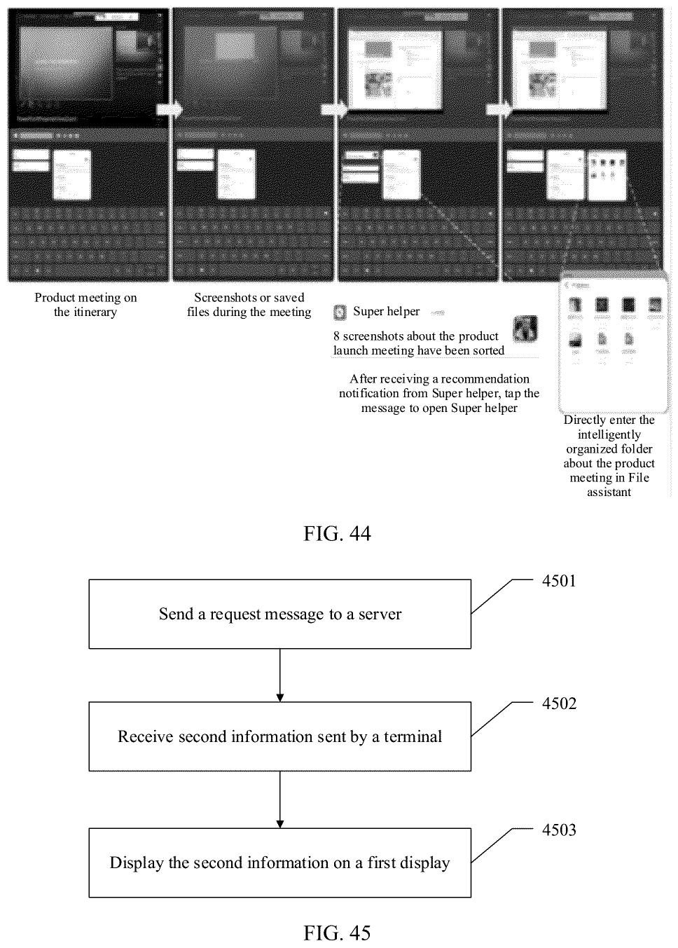

In addition, a card window may be recommended to the user based on some existing operations of the user. For example, in some scenarios where a user uses for a plurality of times, a corresponding function window can be recommended based on user's continuous behavior or a plurality of operations. For example, as shown in FIG. 44, when the user is in a video conference on the plane B, the user takes screenshots of conference content for a plurality of times during a process. After the conference ends, the user may need to sort the saved screenshots. In this application, after the user takes the screenshots for the plurality of times, a message notification window of “The plurality of screenshots of the conference have been arranged” may be first pushed on the plane C. After the conference ends, the user can click the window to open a folder where the screenshots are located.

In addition, for a scenario in which the electronic device interacts with the terminal, if a display is configured for the electronic device, the electronic device may interact with the terminal vi the display, and the information sent by the terminal is displayed on the display. FIG. 45 is a schematic flowchart of another interface display method according to this application. Details are as follows.

4501: Send a request message to a server.

An electronic device, the server, and a terminal establish a connection to each other, and a user transmits data to each other. The electronic device may send the request message to the server, where the request message may be used to request the server to send first information to the terminal.

Specifically, the electronic device may establish a communication connection to the server. The communication connection may include a wired connection, a wireless connection, a combination of a wired connection and a wireless connection, or the like. The server establishes a connection to the terminal, and the server may send information to the terminal.

The server may provide a corresponding service for the electronic device and the terminal. For example, the server may be provided by an operator, and is configured to support a service for the user. The user may use the electronic device to perform the service provided by the server, or may use the terminal to perform the service provided by the server. Generally, the user may use the terminal as a device for identity authentication of the user. For example, the user may use a mobile phone as a login credential of a service. When the user needs to use the electronic device to perform the service provided by the server, if identity verification is required, the user may request the server to send a verification message to the terminal.

4502: Receive second information sent by the terminal.

After the server sends the first information to the terminal, the terminal may send the second information to the electronic device, where the second information may include all or a part of content of the first information.

For example, if the terminal receives the verification message from the server, where the verification message may include a verification code for verifying an identity of the electronic device, the terminal may directly forward the verification message to the terminal device, or may send the verification code carried in the verification message to the electronic device.

4503: Display the second information on a first display.

After receiving the information sent by the terminal, the electronic device may display the second information on the first display.

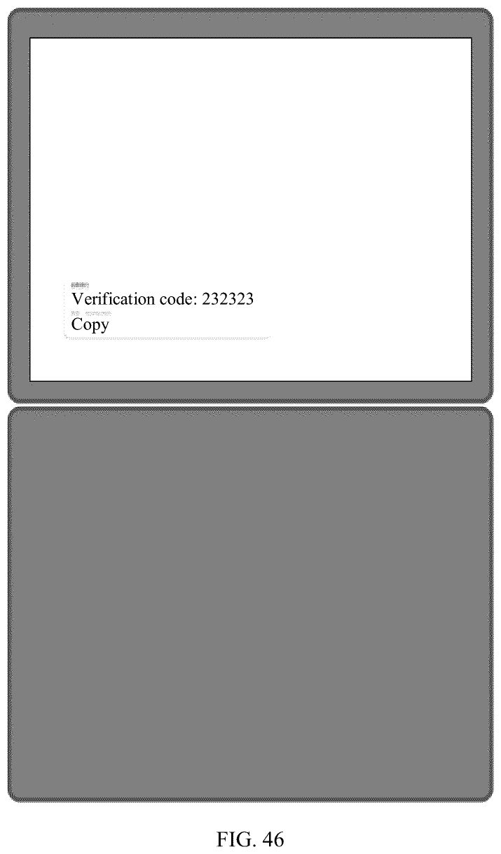

For example, as shown in FIG. 46, the verification message sent by the terminal may be displayed on the display of the plane B of the electronic device, where the verification message carries the verification code. The user may directly select a copy control in a message card to copy the verification code, and input the verification code in a process that needs to be verified, to complete identity verification of the electronic device.

Therefore, in this implementation of this application, the user can obtain the information received by the terminal, without opening the terminal, thereby reducing an operation procedure of the user and improving user experience.

In a possible implementation, similar to the electronic device with the plurality of displays, the electronic device performs the following steps: if detecting that a fourth terminal is in a screen-off state, displaying, on the first display, information sent by the fourth terminal, where the fourth terminal is any one of at least one terminal; or if the second information includes information generated by a first application in the fourth terminal, and the first application is an application included in a preset list, displaying the second information on the first display; or if detecting that the fourth terminal is in a screen-off state, and the second information includes information generated by a second application, displaying the second information on the first display.

Therefore, in this implementation of this application, when the terminal screens off, the information in the terminal can be sent to the electronic device, so that the user can observe, on the electronic device, the information in the terminal, or control the terminal more conveniently, without operating the terminal, thereby improving control experience of the user on each electronic device.

The foregoing describes the interface display method and the GUI provided in this application. The following describes an interface display apparatus provided in this application. The interface display apparatus may be configured to perform steps in the foregoing method.

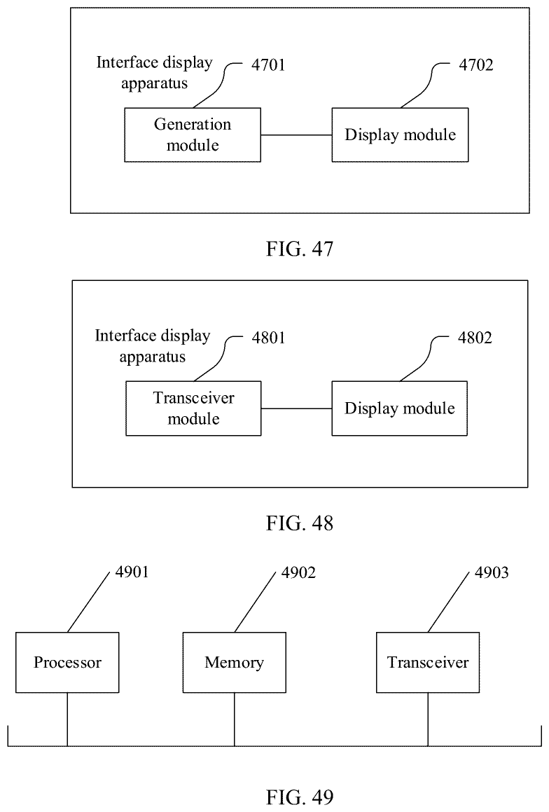

FIG. 47 is a schematic diagram of a structure of an interface display apparatus provided in this application. The apparatus is used in an electronic device. The electronic device includes a first display and a second display, the first display is electrically connected to the second display, and the apparatus includes:
a generation module 4701, configured to determine second display data based on first display data in response to an operation on a display window on the first display, where the first display data is data displayed in the display window on the first display, the second display data includes data corresponding to a selected control in the first display data, and the second display data is less than the first display data; and
a display module 4702, configured to display, on the second display, a window corresponding to the second display data.

In a possible implementation, the display module 4702 is further configured to: if the second display includes a plurality of display windows, in response to a slide operation on the plurality of display windows, select, on the second display based on the slide operation, a preset quantity of windows from the plurality of display windows for display, where the plurality of display windows do not overlap on the second display.

In a possible implementation, the operation on the display window corresponding to the first display data includes at least one of the following operations performed on the first display:
a drag operation, a close operation, a minimize operation, control selection, file selection, a play operation, a gesture operation, or a fold operation; and
the drag operation includes an operation of moving the display window after the display window is selected, the close operation is an operation of closing the display window, the minimize operation is an operation of hiding the display window, the control selection is an operation of selecting a control in the display window, the file selection is an operation of selecting a file displayed in the display window, the play operation is an operation of playing data displayed in the display window, the gesture operation is an operation formed by a gesture for controlling the display window, and the fold operation is adjusting an included angle between the first display and the second display.

In a possible implementation, if the operation on the display window corresponding to the first display data includes the drag operation, the display module 4702 is further configured to use at least one type of data in the first display data as the second display data.

The display module 4702 is further configured to determine a location, on the second display, of the display window of the second display data based on a location at which a cursor is released.

In a possible implementation, if the operation on the display window corresponding to the first display data includes the close operation or the minimize operation, the display module 4702 is specifically configured to scale up or scale down at least one type of data in the first display data, and/or delete at least one type of data in the first display data, to obtain the second display data.

In a possible implementation, if the operation on the display window corresponding to the first display data includes the file selection, and a text in the display window is selected, the display module 4702 is specifically configured to: use the selected text as the second display data; or translate the selected text, to obtain the second display data based on a translation result; or perform searching based on the selected text, to obtain the second display data based on a search result; or arrange the selected text, or obtain an arrangement format corresponding to the selected text, to obtain the second display data; or if the selected text includes a value, perform exchange rate conversion on the value, to obtain the second display data.

In a possible implementation, if the operation on the display window corresponding to the first display data includes the file selection, and an image in the display window is selected, the display module 4702 is specifically configured to: use the selected image as the second display data; or search for a related image of the selected image, to obtain the second display data based on the related image; or perform target detection on the selected image, to obtain the second display data; or perform text recognition on the selected image, to obtain the second display data based on a recognized text.

In a possible implementation, if the operation on the display window corresponding to the first display data includes the play operation, the display module 4702 is specifically configured to: obtain, from the first display data, data related to a picture played on the first display, to obtain the second display data.

In a possible implementation, if the operation on the display window corresponding to the first display data includes the gesture operation, the generation module 4701 is specifically configured to: if detecting that the gesture corresponding to the gesture operation is a preset gesture, use at least one type of data in the first display data as the second display data.

In a possible implementation, if the operation on the display window corresponding to the first display data includes the fold operation, and the included angle between the first display and the second display is within a preset range, the generation module 4701 is specifically configured to use the first display data as the second display data.

In a possible implementation, the display module 4702 is specifically configured to: if detecting that a running application is an application in a preset list, or if detecting that the electronic device is in a preset mode, display, on the second display, the window corresponding to the second display data.

In a possible implementation, a first window on the second display includes third display data, the third display data includes an interface of an application, and the display module 4702 is further configured to: in response to a click operation on a control in the interface of the application, obtain fourth display data corresponding to the control clicked by the click operation, and replace the third display data displayed in an area corresponding to the first window with the fourth display data, where the first window is any window displayed on the second display.

In a possible implementation, a preset area on the second display includes at least one displayed preset window, and the at least one preset window displays at least one of a calendar, weather information, a trip record, a memo, or a note.

In a possible implementation, the display module 4702 is further configured to: if detecting a drag operation on fifth display data displayed on the second display, use an area, corresponding to a location at which a cursor is released, on the second display as a display area of the fifth display data.

In a possible implementation, the display module 4702 is further configured to: obtain information sent by at least one terminal, and display, on the second display, the information sent by the at least one terminal.

In a possible implementation, the information sent by the at least one terminal includes data related to an application corresponding to the first display data.

In a possible implementation, the second display includes at least one window of a preset size that is arranged in a non-overlapping manner, and the display module 4702 is further configured to display, in the at least one window of the preset size that is arranged in the non-overlapping manner, the information sent by the at least one terminal.

In a possible implementation, the display module 4702 is further configured to: obtain information sent by a plurality of terminals, where the plurality of terminals include a first terminal and a second terminal; display, in a second window on the second display, information sent by the first terminal; and display, in the second window in response to a switch operation on the second window, information sent by the second terminal.

In a possible implementation, the display module 4702 is further configured to: send a request message to a server, to indicate the server to send a verification message to a third terminal, where the third terminal is any one of the at least one terminal; and receive information sent by the third terminal, where the information sent by the third terminal includes the verification message.

In a possible implementation, the display module 4702 is further configured to: if detecting that a fourth terminal is in a screen-off state, display, on the second display, information sent by the fourth terminal, where the fourth terminal is any one of the at least one terminal; or if information sent by a fourth terminal includes information generated by a first application, and the first application is an application included in the preset list, display, on the second display, the information sent by the fourth terminal; or if detecting that a fourth terminal is in a screen-off state, and information sent by the fourth terminal includes information generated by a first application, display, on the second display, the information sent by the fourth terminal.

In a possible implementation, the display module 4702 is further configured to: obtain sixth display data on the second display; and if detecting a drag operation on a window corresponding to the sixth display data, generate seventh display data based on the sixth display data, and display the seventh display data on the first display.

In a possible implementation, the display module 4702 is further configured to: obtain historical data displayed on the first display in a preset time period; generate prompt data based on the historical data; and display the prompt data on the second display, where the prompt data is used to prompt an event generated in the historical data.

In a possible implementation, the second display further includes a keyboard window, and the keyboard window displays a virtual keyboard.

In a possible implementation, the display module 4702 is further configured to: if an operation of expanding the second window is detected, and the second window is any window displayed on the second display, close the keyboard window, or reduce a size of the keyboard window, so that the expanded second window does not overlap the reduced keyboard window displayed on the second display.

FIG. 48 is a schematic diagram of a structure of another interface display apparatus provided in this application. The apparatus is used in an electronic device. The electronic device includes a first display, and the apparatus includes:
a transceiver module 4801, configured to send a request message to a server, where the request message is used to request the server to send first information to a terminal, where
the transceiver module 4801 is further configured to receive second information sent by the terminal, where the second information includes the first information; and
a display module 4802, configured to display the second information on the first display.

In a possible implementation, the display module 4802 is specifically configured to:
if detecting that the terminal is in a screen-off state, display, on the first display, information sent by the fourth terminal, where the fourth terminal is any one of at least one terminal; or
if the second information includes information generated by a first application in the terminal, and the first application is an application included in a preset list, display the second information on the first display; or
if detecting that the terminal is in a screen-off state, and the second information includes information generated by a second application, display, on the first display, information sent by the terminal.

FIG. 49 is a schematic diagram of a structure of another interface display apparatus according to this application. Details are as follows.

The interface display apparatus may include a processor 4901 and a memory 4902. The processor 4901 and the memory 4902 are interconnected through a line. The memory 4902 stores program instructions and data.

The memory 4902 stores program instructions and data that correspond to steps in FIG. 5 to FIG. 46.

The processor 4901 is configured to perform the method steps performed by the interface display apparatus in any one of embodiments in FIG. 5 to FIG. 46.

Optionally, the interface display apparatus may further include a transceiver 4903, configured to receive or send data.

An embodiment of this application further provides a computer-readable storage medium. The computer-readable storage medium stores a program used to generate a vehicle travel speed. When the program is run on a computer, the computer is enabled to perform steps in the methods described in embodiments shown in FIG. 5 to FIG. 46.

Optionally, the interface display apparatus shown in FIG. 49 is a chip.

The electronic device provided in embodiments of this application may be specifically a chip. The chip includes a processing unit and a communication unit. The processing unit may be, for example, a processor. The communication unit may be, for example, an input/output interface, a pin, or a circuit. The processing unit may execute computer-executable instructions stored in a storage unit, so that a chip in a server performs the interface display method described in embodiments shown in FIG. 5 to FIG. 46. Optionally, the storage unit is a storage unit in the chip, for example, a register or a cache. The storage unit may alternatively be a storage unit that is in a wireless access device and that is outside the chip, for example, a read-only memory (read-only memory, ROM) or another type of static storage device that can store static information and instructions, or a random access memory (random access memory, RAM).

Specifically, the processing unit or the processor may be a central processing unit (central processing unit, CPU), a network processor (neural-network processing unit, NPU), a graphics processing unit (graphics processing unit, GPU), a digital signal processor (digital signal processor, DSP), an application-specific integrated circuit (application-specific integrated circuit, ASIC), a field programmable gate array (field programmable gate array, FPGA), another programmable logic device, a discrete gate, a transistor logic device, a discrete hardware component, or the like. A general-purpose processor may be a microprocessor or any regular processor or the like.

The processor mentioned above may be a general-purpose central processing unit, a microprocessor, an ASIC, or one or more integrated circuits for controlling program execution of the methods in FIG. 5 to FIG. 46.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected according to actual requirements to achieve the objectives of the solutions of embodiments. In addition, in the accompanying drawings of the apparatus embodiments provided by this application, connection relationships between modules indicate that the modules have communication connections with each other, and may be specifically implemented as one or more communication buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, like a floppy disk, a USB flash drive, a removable hard disk, a read-only memory (read-only memory, ROM), a random access memory (random access memory, RAM), a magnetic disk, or an optical disc of a computer, and includes several instructions for instructing a computer device (which may be a personal computer, a server, a network device, or the like) to perform the methods described in embodiments of this application.

All or some of the foregoing embodiments may be implemented by using software, hardware, firmware, or any combination thereof. When software is used to implement embodiments, all or some of embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, like a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state disk, SSD)), or the like.

In the specification, claims, and accompanying drawings of this application, the terms “first”, “second”, “third”, “fourth”, and the like (if existent) are intended to distinguish between similar objects but do not necessarily indicate a specific order or sequence. It should be understood that the data termed in such a way are interchangeable in appropriate circumstances, so that embodiments described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

Finally, it should be noted that the foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-26. (canceled)

27. A method, applied to an electronic device, wherein the electronic device comprises a first display and a second display, the first display is electrically connected to the second display, and the method comprises:
determining second display data based on first display data in response to an operation on a display window on the first display, wherein the first display data is displayed in the display window on the first display, the second display data corresponds to a selected control in the first display data, and the second display data is smaller or simpler than the first display data; and
displaying, on the second display, a window corresponding to the second display data.

28. The method according to claim 27, wherein:
the second display comprises a plurality of display windows, and
the method further comprises, in response to a slide operation on the plurality of display windows, selecting, on the second display based on the slide operation, a preset quantity of windows from the plurality of display windows that are displayed, wherein the plurality of display windows do not overlap on the second display.

29. The method according to claim 27, wherein the operation on the display window corresponding to the first display data comprises at least one of:
a drag operation, a close operation, a minimize operation, a control selection, a file selection, a play operation, a gesture operation, or a fold operation; and
the drag operation is moving the display window after the display window is selected,
the close operation is closing the display window,
the minimize operation is hiding the display window,
the control selection is selecting a control in the display window,
the file selection is selecting a file displayed in the display window,
the play operation is playing data displayed in the display window,
the gesture operation is formed by a gesture for controlling the display window, and
the fold operation is adjusting an included angle between the first display and the second display.

30. The method according to claim 29, wherein:
the operation on the display window corresponding to the first display data comprises the drag operation, and determining the second display data based on the first display data comprises:
using at least one type of data in the first display data as the second display data; and
displaying, on the second display, the window corresponding to the second display data comprises:
determining a location, on the second display, of the display window of the second display data based on a location at which a cursor is released.

31. The method according to claim 29, wherein:
the operation on the display window corresponding to the first display data comprises the close operation or the minimize operation, determining the second display data based on the first display data comprises:
obtaining the second display data by:
scaling up or scaling down at least one type of data in the first display data, or deleting the at least one type of data in the first display data.

32. The method according to claim 29, wherein:
the operation on the display window corresponding to the first display data comprises the file selection, and a text in the display window is selected, determining the second display data based on the first display data comprises:
using the selected text as the second display data; or
translating the selected text, to obtain the second display data based on a translation result; or
obtaining the second display data based on a search result by performing searching based on the selected text; or
obtaining the second display data, the second display data obtained by arranging the selected text or obtaining an arrangement format corresponding to the selected text; or
wherein the selected text comprises a value, obtaining the second display data by performing exchange rate conversion on the value.

33. The method according to claim 29, wherein:
the operation on the display window corresponding to the first display data comprises the file selection, and an image in the display window is selected, determining the second display data based on the first display data comprises:
using the selected image as the second display data; or
obtaining the second display data based on a related image by searching for the related image using the selected image; or
obtaining the second display data by performing target detection on the selected image; or
obtaining the second display data based on a recognized text by performing text recognition on the selected image.

34. The method according to claim 29, wherein:
the operation on the display window corresponding to the first display data comprises the play operation, determining the second display data based on the first display data comprises:
obtaining the second display data by obtaining, from the first display data, data related to a picture played on the first display.

35. The method according to claim 29, wherein:
the operation on the display window corresponding to the first display data comprises the gesture operation, determining the second display data based on the first display data comprises:
detecting that a gesture corresponding to the gesture operation comprises a preset gesture, using at least one type of data in the first display data as the second display data.

36. The method according to claim 29, wherein:
the operation on the display window corresponding to the first display data comprises the fold operation, and the included angle between the first display and the second display is within a preset range, determining the second display data based on the first display data comprises:
using the first display data as the second display data.

37. The method according to claim 27, wherein displaying, on the second display, the window corresponding to the second display data comprises:
detecting that a running application is in a preset list, or detecting that the electronic device is in a preset mode, displaying, on the second display, the window corresponding to the second display data.

38. The method according to claim 27, further comprising:
obtaining information sent by at least one terminal; and
displaying, on the second display, the information sent by the at least one terminal.

39. The method according to claim 38, wherein obtaining the information sent by the at least one terminal comprises:
obtaining information sent by a plurality of terminals, wherein the plurality of terminals comprise a first terminal and a second terminal; and
displaying, on the second display, the information sent by the at least one terminal comprises:
displaying, in a second window on the second display, information sent by the first terminal; and
displaying, in the second window and in response to a switch operation on the second window, information sent by the second terminal.

40. The method according to claim 38, wherein displaying, on the second display, the information sent by the at least one terminal comprises:
detecting that a fourth terminal is in a screen-off state, displaying, on the second display, information sent by the fourth terminal, wherein the fourth terminal comprises any terminal of the at least one terminal; or
wherein information sent by the fourth terminal comprises information generated by a first application, and the first application is in a preset list, displaying, on the second display, the information sent by the fourth terminal; or
detecting that the fourth terminal is in the screen-off state, and information sent by the fourth terminal comprises information generated by the first application, displaying, on the second display, the information sent by the fourth terminal.

41. A method, applied to an electronic device, wherein the electronic device comprises a first display, and the method comprises:
sending a request message to a server, wherein the request message is used to request the server to send first information to a terminal;
receiving second information sent by the terminal, wherein the second information comprises the first information; and
displaying the second information on the first display.

42. The method according to claim 41, wherein displaying the second information on the first display comprises:
detecting that the terminal is in a screen-off state, displaying, on the first display, information sent by a fourth terminal, wherein the fourth terminal comprises any terminal of at least one terminal; or
wherein the second information comprises information generated by a first application in the terminal, and the first application is in a preset list, displaying the second information on the first display; or
detecting that the terminal is in a screen-off state, and the second information comprises information generated by a second application, displaying, on the first display, information sent by the terminal.

43. An electronic device, wherein the electronic device comprises a first display, a second display, at least one memory, and one or more processors, the at least one memory stores code associated with a graphical user interface (GUI) of an application, and the one or more processors are configured to execute the code associated with the graphical user interface stored in the at least one memory, to:
display the graphical user interface on the first display or the second display;
determine second display data based on first display data in response to an operation on a display window on the first display, wherein the first display data is displayed in the display window on the first display, the second display data corresponds to a selected control in the first display data, and the second display data is smaller or simpler than the first display data; and
display, on the second display, a window corresponding to the second display data.

44. The electronic device according to claim 43, wherein:
the second display comprises a plurality of display windows, and
the one or more processors are configured to further execute the code associated with the graphical user interface stored in the at least one memory, to, in response to a slide operation on the plurality of display windows, selecting, on the second display based on the slide operation, a preset quantity of windows from the plurality of display windows that are displayed, wherein the plurality of display windows do not overlap on the second display.

45. The electronic device according to claim 43, wherein the operation on the display window corresponding to the first display data comprises at least one of:
a drag operation, a close operation, a minimize operation, a control selection, a file selection, a play operation, a gesture operation, or a fold operation; and
the drag operation is moving the display window after the display window is selected, the close operation is closing the display window,
the minimize operation is hiding the display window,
the control selection is selecting a control in the display window,
the file selection is selecting a file displayed in the display window,
the play operation is playing data displayed in the display window,
the gesture operation is formed by a gesture for controlling the display window, and
the fold operation is adjusting an included angle between the first display and the second display.

46. The electronic device according to claim 45, wherein:
the operation on the display window corresponding to the first display data comprises the drag operation, determining the second display data based on the first display data comprises:
using at least one type of data in the first display data as the second display data; and
displaying, on the second display, the window corresponding to the second display data comprises:
determining a location, on the second display, of the display window of the second display data based on a location at which a cursor is released.
